(19) United States
(12) Patent Application Publication
(10) Pub. No.: US 2026/0032071 A1
(43) Pub. Date: Jan. 29, 2026

(54) SYSTEMS AND METHODS FOR TROUBLESHOOTING AND MANAGING PERFORMANCE OF NETWORK DEVICES

(71) Applicant: Hughes Network Systems, LLC, Germantown, MD (US)

(72) Inventor: Douglas Merrill DILLON, Rockville, MD (US)

(73) Assignee: Hughes Network Systems, LLC, Germantown, MD (US)

(21) Appl. No.: 18/781,603

(22) Filed: Jul. 23, 2024

(51) Int. Cl. H04L 43/50; H04L 43/0829; H04L 43/0864; H04L 47/34

(52) U.S. Cl. CPC H04L 43/50; H04L 43/0829; H04L 43/0864; H04L 47/34

(57) ABSTRACT

Systems and methods for troubleshooting and managing performance of network devices are disclosed. A system includes a router. The router monitors data packets between a Wide Area Network (WAN) and the customer premise equipment during an upstream transmission and a downstream transmission and determines packet parameters and device parameters associated with the plurality of customer premise equipment. Further, the router identifies a customer premise equipment and characteristics and determines status information and performance information of the identified customer premise equipment based on the determined plurality of characteristics and the predefined device match rules. Furthermore, the router determines issues of the identified customer premise equipment and generates recommendations including troubleshooting solutions for the determined issues. The router transmits the recommendations to at least one of user devices and a server managing the router.

### TECHNICAL FIELD

This patent application is directed to communication systems and, more specifically, to systems and methods for troubleshooting customer premise devices and managing performance of the customer premise devices.

### BACKGROUND

Generally, troubleshooting network connectivity problems at customer locations may have various challenges and limitations. One such example may include limited access to router settings. In some examples, customers or users may not have complete access to the router settings in case a router is provided by an Internet Service Provider (ISP). In this case, the users may have limited configuration options which may restrict troubleshooting steps that may be performed. In some cases, the users or a technician may be provided with limited troubleshooting tools or software that may provide detailed information related to network performance, a signal strength, an interference, and other factors affecting the network connectivity. As a result, troubleshooting may become more challenging without access to the troubleshooting tools by the users or the technician.

Furthermore, in the case of complex network environments, there may be multiple routers, access points, or network extenders deployed within such network environments. In this case, identifying an issue in a network environment may require complicated and time-consuming techniques, which may delay the overall troubleshooting process. Some existing examples may depend mainly on an ISP router using a Media Access Control Address (MAC) of a network device to identify a device causing the issue. Each manufacturer may typically purchase a range of MAC addresses and a lookup table based on a subset of the MAC address that may help in identifying the device (i.e., a network device). However, some network devices may select a random MAC address to avoid surveillance tracking of the device. This method further increases the complexity of device identification in case of occurrence of the issue in the network environment. Further, MAC address-based identification of the device may also not be feasible when the network device accesses a home network via a downstream router connected to the ISP router.

In some examples, the network devices may publish a host name which the ISP router may associate with a given IP address. This helps to identify the network devices. Further, the host name may be cryptic and hence may not be feasible for the users or the technicians to identify the network device. Furthermore, the host name may be unavailable to the ISP Router when the network device connects to the network via a downstream router as the host name is typically learned by a Dynamic Host Configuration Protocol (DHCP) server (in this case, in the downstream router).

Consequently, there may be a need for an improved system and method for providing a router with enhanced remote fault detection, troubleshooting, and managing performance of the network devices.

### SUMMARY

This summary is provided to introduce a selection of concepts, in a simple manner, which is further described in the detailed description of the disclosure. This summary is neither intended to identify essential inventive concepts of the subject matter nor to determine the scope of the disclosure.

An aspect of the present disclosure provides a router. The router includes a processor and a memory coupled to the processor. The memory includes processor-executable instructions, which on execution, cause the processor to monitor data packets communicated between a wide area network (WAN) and a plurality of customer premise equipment during an upstream transmission and a downstream transmission. The processor is further caused to determine a plurality of packet parameters associated with the monitored data packets and a plurality of device parameters associated with the plurality of customer premise equipment based on the monitored data packets and validate the determined plurality of packet parameters and the plurality of device parameters based on predefined device match rules. Thereafter, the processor is caused to identify a customer premise equipment along with a plurality of characteristics from the plurality of customer premise equipment based on results of the validation. The plurality of characteristics includes a device type, a device name, and a device description.

Another aspect of the present disclosure provides a method. The method includes monitoring, by the processor, data packets communicated between a wide area network (WAN) and a plurality of customer premise equipment during an upstream transmission and a downstream transmission. The method further includes determining, by the processor, a plurality of packet parameters associated with the monitored data packets and a plurality of device parameters associated with the plurality of customer premise equipment based on the monitored data packets and validating, by the processor, the determined plurality of packet parameters and the plurality of device parameters based on predefined device match rules. The method includes identifying, by the processor, a customer premise equipment along with a plurality of characteristics from the plurality of customer premise equipment based on results of the validation. The plurality of characteristics includes a device type, a device name, and a device description.

Yet another aspect of the present disclosure provides a non-transitory computer-readable medium including machine-readable instructions that are executable by a processor. The processor monitors data packets communicated between a wide area network (WAN) and a plurality of customer premise equipment during an upstream transmission and a downstream transmission. The processor determines a plurality of packet parameters associated with the monitored data packets and a plurality of device parameters associated with the plurality of customer premise equipment based on the monitored data packets. Further, the processor validates the determined plurality of packet parameters and the plurality of device parameters based on predefined device match rules. The processor identifies a customer premise equipment along with a plurality of characteristics from the plurality of customer premise equipment based on results of the validation. The plurality of characteristics includes a device type, a device name, and a device description.

To further clarify the advantages and features of the present disclosure, a more particular description of the disclosure will follow by reference to specific embodiments thereof, which are illustrated in the appended figures. It is to be appreciated that these figures depict typical embodiments of the disclosure and are therefore not to be considered limiting in scope. The disclosure will be described and explained with additional specificity and detail with the appended figures.

### BRIEF DESCRIPTION OF DRAWINGS

Features of the disclosed embodiments are illustrated by way of example and not limited in the following Figure(s), in which like numerals indicate like elements, in which:

FIG. 1A illustrates an example block diagram representation of a network architecture implementing a router capable of managing network communication and providing a management point-of-service, according to an example.

FIG. 1B illustrates an example block diagram representation of a network architecture capable of managing network communication and providing a management point-of-service, according to an example.

FIG. 2 illustrates an example block diagram representation of a router, according to an example.

FIGS. 3A and 3B illustrate example flow diagram representations of a method for monitoring upstream transmission, according to an example.

FIGS. 4A and 4B illustrate example flow diagram representations of a method for monitoring downstream transmission, according to an example.

FIGS. 5A and 5B illustrate example flow diagram representations of a method for identifying a customer premise equipment along with a plurality of characteristics from among a plurality of customer premise equipment based on the results of validation, according to an example.

FIGS. 6A and 6B illustrate example flow diagram representation of a method for determining a status information and a performance information associated with the identified customer premise equipment, according to an example.

FIG. 7A illustrates an example block diagram representation of device status monitoring data structures, according to an example.

FIG. 7B illustrates an example representation of Media Access Control (MAC) address format, according to an example.

FIG. 8 illustrates an example flow diagram representation of a method for providing troubleshooting solutions for network related issues at a customer premise, according to an example.

FIG. 9 illustrates an example block diagram representation of a computer system, according to an example.

Further, those skilled in the art will appreciate those elements in the figures are illustrated for simplicity and may not have necessarily been drawn to scale. Furthermore, in terms of the construction of the device, one or more components of the device may have been represented in the figures by conventional symbols, and the figures may show those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are illustrative and not intended to be limiting. A computer system (standalone, client, server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

The disclosed technology falls generally within the field of networking technology and deals with the subject of Internet access. The geosynchronous satellites may provide ubiquitous connectivity but operate with an order of magnitude higher latency than terrestrial network connectivity and where TCP spoofing may be used to reduce the effect of latency on bulk transfer throughput, wireless cell phone-oriented networking, for example, using technologies such as fourth generation (4G), long term evolution (LTE) and fifth generation (5G), sixth generation (6G), and/or other wireless technologies, to provide wireless connectivity to the Internet; software-defined wide area networking (SD-WAN), for example, where multiple (typically two) broadband transports are combined to provide better service and availability than what is provided by either transport individually.

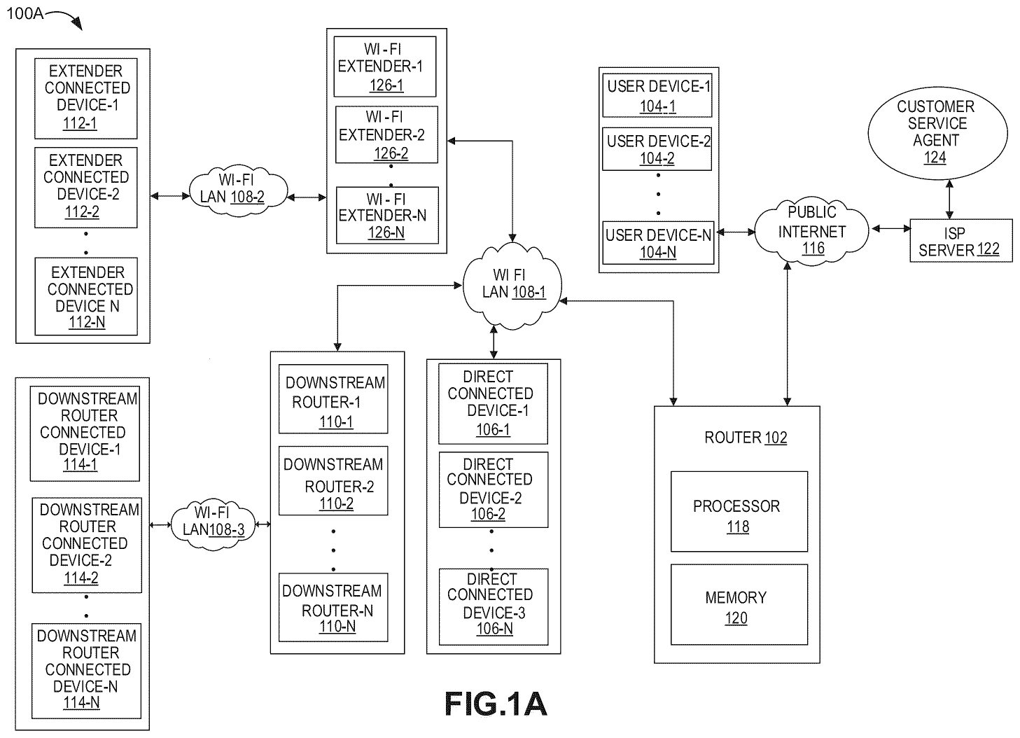

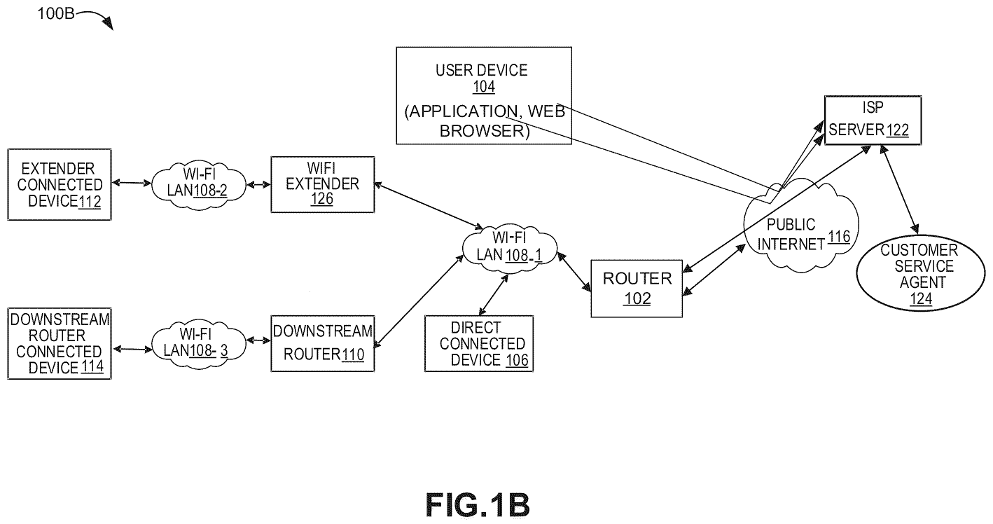

Referring now to the drawings, and more particularly to FIGS. 1A-1B through FIG. 9, where similar reference characters denote corresponding features consistently throughout the figures, there are shown preferred embodiments, and these embodiments are described in the context of the following exemplary system and/or method.

FIG. 1A illustrates an example block diagram representation of a network architecture 100A implementing a router 102 capable of managing network communication and providing a management point-of-service, according to an example. It should be appreciated that the router 102 depicted in FIG. 1A may be an example. Hence, the router 102 may or may not include additional features and some of the features described herein may be removed and/or modified without departing from the scopes of the router 102 outlined herein. In some examples, the network architecture 100A may depict a satellite communication system capable of providing at least voice and/or data services. In one example, the network architecture 100A includes a plurality of user devices 104-1-N (collectively referred to as user device 104-1-N or user devices 104) and a plurality of customer premise equipment. The plurality of customer premise equipment is communicatively coupled to the plurality of user devices 104-1 to 104-N via a first communication network (not shown in FIG. 1A). In an example, the plurality of user devices 104-1-N may be for example, but not limited to, cell phone, handheld devices, smart phones, laptops, personal computers, tablets, or any other user equipment. The plurality of user devices 104-1-N may be used for troubleshooting the devices (such as a LAN device 108-1, a LAN device 108-2, and a LAN device 108-3). The plurality of user devices 104-1-N may be connected independently to a public internet 116 (also referred herein as Internet 116 or Wide Area Network (WAN) 116) from the router 102. In one example, the plurality of user devices 104-1-N may use software applications or web applications to perform the troubleshooting. For example, the plurality of user devices 104-1-N may perform troubleshooting using a web browser or a software application installed on the plurality of user devices 104-1-N.

The plurality of customer premise equipment may include at least one of local area network (LAN) devices 108 (such as a LAN device 108-1, a LAN device 108-2, and a LAN device 108-3), a plurality of network routers 110 (also collectively referred herein as the network routers 110), a plurality of network extenders 126 (also collectively referred herein as the network extenders 112), and a plurality of connected devices. The plurality of network routers 110 may include, for example, but not limited to, downstream router 110-1-N. The plurality of network extenders 126 may include, for example, but not limited to, Wi-Fi extender 126-1-N. The plurality of connected devices may include one of extender connected devices 112-1-N, downstream router connected devices 114-1-N, and direct connected device 106-1-N. One of ordinary skill in the art will appreciate that the network extenders 112 and the downstream routers 110-1 to 110-N may be used to enhance the coverage and strength of a Wi-Fi network established by the LAN devices 108-1 to 108-3.

Further, the router 102 is communicably coupled to the plurality of user devices 104-1 to 104-N via a public Internet 116 (also referred herein as Internet 116). Further, the router 102 is communicably coupled to the plurality of customer premise equipment via a second communication network 108-1. The Internet 116 is hereinafter interchangeably referred to as the wide area network (WAN) 116. The router 102 includes a processor 118 and a memory 120 coupled to the processor 118. In an example, the router 102 may be, for example, but not limited to, an Internet Service Provider (ISP) router connecting the LAN devices 108-1 to 108-N to the wide area network (WAN) 116 (such as Internet). The memory 120 includes processor-executable instructions, which on execution, cause the processor 118 to perform one or more operations described herein.

In an example, the router 102 may be implemented as a standalone device such as a networking apparatus or device. In an example, each of the customer premise equipment may be implemented as a standalone device. In another example, the customer premise equipment may be implemented and integrated into an existing network device/network apparatus.

In some examples, the network architecture 100A may also include a private network and/or public network (not shown in FIG. 1A). The private network and/or public network may include any variations of networks. For example, the private network may be a Local Area Network (LAN), and the public network may be a Wide Area Network (WAN). Also, the private network and/or public network may each be a Local Area Network (LAN), Wide Area Network (WAN), the Internet, a cellular network, a cable network, a satellite network, or other network that facilitates communication between the components of network architecture 100A as well as any external element or system connected to the private network and/or public network. The private network and/or public network may further include one, or any number, of the exemplary types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public network may be a single network, it should be appreciated that in some examples, each of the private network and/or public network may include a plurality of interconnected networks as well.

Further, the network architecture 100A may include terminals (not shown in FIG. 1A) which may be used by, but is not limited to, a user, a customer, an administrator, a network operator, a flight/ship operator, a driver, and/or type of users. Depending on the application, the terminals may include or incorporate any number of antenna dishes, which may be provided in various sizes, depths, or dimensions (for example, small, medium, or large). Although the terminals may typically remain in the same location once mounted, the terminals may be removed from their mounts, relocated to another location, and/or may be configured to be mobile terminals. For example, the terminals may be mounted on mobile platforms that facilitate transportation thereof from one location to another. Such mobile platforms may include, for example, any number of mobile vehicles, such as airplanes, cars, buses, boats, trucks, troop-carriers, or other vehicles, and/or other type of vehicles/commuting means. It should be appreciated that such terminals may generally be operational when still and not while being transported. That said, there may be examples where the terminals may be transportable (mobile) terminals that remain operational during transit. As used herein, the terms “terminal,” “customer terminal,” “satellite terminal,” and/or “very small aperture terminal (VSAT)” may be used interchangeably to refer to these terminal types.

It should be appreciated that any number of customer-premise equipment (CPE) (such as the plurality of customer premise equipment) may be communicatively coupled to the terminals. In some examples, the customer premise equipment (CPE) may include any number of computing or mobile devices. For example, such a computing or mobile device may include, but is not limited to, a laptop, a tablet, a mobile phone, an appliance, a camera, a sensor, a thermostat, a vehicle, a display, and/or other interfaces. In general, the customer premise equipment (CPE) may include, without limitation, any number of network-enabled computing devices, elements, or systems. It should be appreciated that a network of such devices may be commonly referred to as “Internet of Things” (IoT). The CPE may be provided as a standalone, transport integrated, hybrid integrated, or fully integrated single device solution. In the standalone configuration, all WAN modems and accelerators are provided as standalone devices.

In another example, a point of presence (POP) or a network operation center (NOC) may be included in the network architecture 100. For example, the POP may be instantiated for load balancing and scaling to load. The location of the POP may be strategic to optimize transport modem characteristics such as latency, jitter, throughput, and/or network issues. The POP may include virtual private network (VPN) firewalls to block unwanted intrusion or malicious software/connections. The POP may serve as an endpoint to additional VPN tunnels. Multiple VPN firewalls may be desired for scalability and load balancing. The POP may include one or more enterprise routers to route traffic between the accelerator gateway and the public Internet 116. Routers may route traffic to private networks. Multiple routers may exist for scaling and load balancing.

Further, the network architecture 100A may include a satellite (not shown in FIG. 1A) which may be an object intentionally placed into orbit. In some examples, the satellite may be an artificial satellite that may be configured to transmit and receive data signals. In some examples, the satellite may be a communication satellite, such as a high-throughput satellite, which may include any satellite that may be capable of providing at least twice (for example, 20+ times, 100+ times, and the like) the total amount of throughput as a classic fixed-satellite service (FSS) satellite. In some examples, the satellite may include, but is not limited to, a transponder satellite, a regenerative satellite, and/or other similar satellite that may generate one or more spot beams. Furthermore, in some examples, the satellite may operate in geosynchronous, mid-earth, low-earth, elliptical, or some other orbital configuration. For example, a geostationary earth orbit (GEO) spot beam, a low-earth orbit (LEO) satellite, a medium earth orbit spot beam, and/or other types of spot beam.

While the processors, components, elements, systems, subsystems, and/or other computing devices may be shown as single components or elements, one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the network architecture 100, and components, as shown in FIG. 1A.

In an example, the router 102 may periodically monitor data packets communicated between the WAN 116 and the plurality of customer premise equipment during an upstream transmission and a downstream transmission.

In an example, the router 102 may determine a plurality of packet parameters associated with the monitored data packets and a plurality of device parameters associated with the plurality of customer premise equipment based on the monitored data packets. The plurality of packet parameters may include, but not limited to, an acknowledgement (ACK) time of downstream transmission control protocol (TCP) data packets, an upstream and a downstream packet loss, a destination Internet Protocol (IP) address, a server domain and a server domain name, a server domain history and a server domain name history, a packet size, a TCP retransmission information, and a TCP out-of-sequence packet reception. Further, the plurality of device parameters may include, but not limited to, a round-trip latency, a Media Access Control (MAC) address, a domain history, a domain name history, a data traffic history, a maximum daily byte usage, a minimum daily byte usage, a maximum number of domains, a minimum number of domains, a minimum downstream percentage, a maximum downstream percentage, a device IP address, device statistics, a device manufacturer name, a TCP connection establishment information and a TCP segment acknowledgement latency, a LAN congestion, and a device network connectivity.

In an example, the router 102 may validate the determined plurality of packet parameters and the plurality of device parameters based on predefined device match rules. The processor 118 of the router 102 may compare at least one of the determined plurality of packet parameters and the plurality of device parameters with the predefined device match rules. Further, the processor 118 of the router 102 may determine at least one matching rule with the highest resulting score based on the comparison. Each of the at least one matching rule may be configured in an example, as a comma-separated value list comprising key-value pairs. Furthermore, the processor 118 of the router 102 may identify at least one of a MAC address, a vendor value and a hostname corresponding to the determined at least one matching rule.

In an example, the router 102 may identify a customer premise equipment (for example, the LAN device 108-1) along with a plurality of characteristics from the plurality of customer premise equipment based on results of the validation. The plurality of characteristics may include, but not limited to, a device type, a device name, and a device description. In particular, the processor 118 of the router 102 identifies a type of the customer premise equipment (for example, the LAN device 108-1) based on at least one matching rule. The at least one matching rule may include pre-stored device parameters and pre-stored packet parameters matching the plurality of packet parameters and the plurality of device parameters. The processor 118 of the router 102 may determine a device name and a device description associated with the identified type of customer premise equipment (for example, the LAN device 108-1) based on the at least one matching rule. Further, the processor 118 of the router 102 may determine at least one of an operating system hosted on the customer premise equipment (for example, the LAN device 108-1) and at least one latest applications used by the customer premise equipment (for example, the LAN device 108-1).

In an example, the router 102 may determine a status information and a performance information associated with the identified customer premise equipment (for example, the LAN device 108-1) based on the determined plurality of characteristics and the predefined device match rules. The performance information may include at least a device network latency measurement and packet loss measurements.

In an example, the router 102 may determine at least one issue associated with the identified customer premise equipment (for example, the LAN device 108-1) based on the determined status information and the performance information.

In particular, the processor 118 of the router 102 may measure at least one of a round-trip latency of the identified customer premise equipment (for example, the LAN device 108-1) and an upstream and downstream packet loss of the identified customer premise equipment (for example, the LAN device 108-1). The round-trip latency is measured by monitoring an acknowledgement (ACK) time of the data packets during the downstream transmission and a TCP sequence number. The upstream and downstream packet loss are measured by monitoring the data packets. Further, the processor 118 of the router 102 may determine a signal strength of the identified customer premise equipment (for example, the LAN device 108-1) based on a MAC address associated with the identified customer premise equipment (for example, the LAN device 108-1) and the measured at least one of the round-trip latencies and the upstream and the downstream packet loss. The processor 118 of the router 102 may determine the status information of the identified customer premise equipment (for example, the LAN device 108-1) based on the measured at least one of the round-trip latency and the upstream and the downstream packet loss. The status information may include, but not limited to, one of a device active state and a device idle state. The status information further includes, but not limited to, at least one of the MAC address, an IP address, a server domain name history, a server domain history, a traffic history, and MAC manufacturer information.

Further, the processor 118 of the router 102 may evaluate the measured at least one of the round-trip latencies of the identified customer premise equipment (for example, the LAN device 108-1) and the upstream and the downstream packet loss of the identified customer premise equipment (for example, the LAN device 108-1) based on a pre-set threshold values. The processor 118 of the router 102 may evaluate the signal strength of the identified customer premise equipment (for example, the LAN device 108-1) based on the pre-set threshold values. The processor 118 of the router 108 may further determine the at least one issue associated with the identified customer premise equipment (for example, the LAN device 108-1) based on evaluated round-trip latency, the upstream and the downstream packet loss and the evaluated signal strength. The at least one issue may include, but not limited to, at least one of a signal connectivity issue, network congestion issue, a round-trip time issue, a customer premise equipment infrastructure issue, a packet loss issue, and a packet sequence number error issue (or, specifically, TCP packet sequence number error issue, and the like.

In an example, the threshold mentioned below may be used to evaluate a connectivity of the LAN device 108-1-N. Below Table. 1 depicts some example thresholds for LAN latency and packet loss:

TABLE 1

| Metric | Threshold |
|---|---|
| Upstream | GOOD: <0.5% |
| Packet Loss | FAIR: 0.5-2.5% |
| | POOR: >2.5% |
| Downstream | GOOD: <0.5% |
| Packet Loss | FAIR: 0.5-1.5% |
| | POOR: >1.5% |
| Latency | GOOD: <20 ms |
| | FAIR: 20 ms-50 ms |
| | POOR: >50 ms |

In an example, in a GOOD threshold, the upload, download and webpage load time performance remains at 80% higher than performance obtained with EXCELLENT LAN (no packet loss with latency of <5 ms).

In an example, in a FAIR threshold, the upload, download and webpage load time performance remains within [80%, 50%] of the performance obtained with EXCELLENT LAN.

In an example, in a POOR threshold, the upload, download and webpage load time performance falls below 50% of the performance obtained with EXCELLENT LAN.

In an example, the router 102 may generate a plurality of recommendations corresponding to the determined at least one issue based on pre-stored rules. The generated plurality of recommendations may include, but not limited to, at least a plurality of troubleshooting solutions for the determined at least one issue. The processor 118 of the router 102 may map the determined at least one issue with a corresponding prestored issue. Further, the processor 118 of the router 102 may identify a plurality of troubleshooting solutions for the determined at least one issue based on the mapping. Thereafter, the processor 118 of the router 102 may generate a plurality of recommendations for the determined at least one issue. The plurality of recommendations may include the identified plurality of troubleshooting solutions. The troubleshooting solutions may include a systematic process of identifying, diagnosing, and resolving problems or issues associated with the plurality of customer premise equipment. Further, executing the troubleshooting solutions aims to restore normal operation, improve performance, and ensure the functions of the plurality of customer premise equipment as intended.

In an example, the router 102 may transmit the generated plurality of recommendations to at least one of the plurality of user devices (for example, the user device 104-1) and a server managing the router 102. As shown in FIG. 1A, the server managing the router 102 is a server 122. The router 102 is typically managed by the server 122 and may provide the status and statistics of the customer premise equipment upstream to the server 122. This enables a customer service agent 124 to access the aforementioned information during a customer service call or to the end-user via a website or an application that accesses server 122.

In one example, in monitoring the data packets communicated between the WAN 116 and the plurality of customer premise equipment during the upstream transmission, the processor 118 receives an upstream data packet corresponding to each of the plurality of customer premise equipment by the processor 118 of the router 102. Thereafter, the processor 118 of the router 102 extracts a source MAC address, and an IP address associated with the received upstream data packet. The processor 118 of the router 102 may map the extracted source MAC address and the IP address with a pre-stored MAC address and a pre-stored IP address. Furthermore, the processor 118 of the router 102 may determine a manufacturer name associated with the plurality of customer premise equipment based on the mapping. The processor 118 of the router 102 may extract a server domain and a server domain name from the received upstream data packet based on a type of the upstream data packet. The processor 118 of the router 102 may update a device upstream traffic information with a packet size in a device traffic history table. Further, the processor 118 of the router 102 may update each device table entry for each of the plurality of customer premise equipment by applying the predefined device match rules. Additionally, the processor 118 may extract the server domain and the server domain name from the received downstream data packet based on a type of the downstream data packet.

In an example, in monitoring the data packets communicated between the WAN 116 and the plurality of customer premise equipment during the downstream transmission, the processor 118 receives a downstream data packet by the processor 118 of the router 102. The downstream data packet is transmitted to each of the plurality of customer premise equipment from the WAN 116. The processor 118 of the router 102 may extract an IP address associated with the received downstream data packet. Further, the processor 118 of the router 102 may update a device downstream traffic information with a packet size in a device traffic history table. Furthermore, the processor 118 of the router 102 may update each device table entry for each of the plurality of customer premise equipment by applying the predefined device match rules.

Although the above steps and the operation of the system has been explained to be performed by the router 102, in an alternate example, the steps and the operation may also be performed by any other network device capable of, such as for example, but not limited to, a server 122. A person with ordinary skill may envision the same network architecture 100A and the other examples described herein to be performed by the server 122 or any other equivalent devices.

FIG. 1B illustrates an example block diagram representation of a network architecture 100b, in accordance with an example. The network architecture 100b includes a router 102. The router 102 may or may not include additional features and some of the features described herein may be removed and/or modified without departing from the scopes of the router 102 outlined herein. In some examples, the network architecture 100B may depict a satellite communication system capable of providing at least voice and/or data services. The router 102 provides connectivity to the home network (and optionally wireless fidelity (Wi-Fi) service) and provides a management point-of-presence.

Further, a customer premise may include multiple devices (as shown in FIG. 1B). In an example, some devices of the customer premise may directly access the WI-FI network of the router 102 allowing the router 102 visibility into the MAC address of a device, IP address and signal quality (typically depicted as zero or more “bars”).

In one example, the network architecture 100b may include a user device 104, and a plurality of customer premise equipment. The plurality of customer premise equipment may include at least one of Local Area Network (LAN) devices 108 (such as a LAN device 108-1, a LAN device 108-2, and a LAN device 108-3), a downstream router 110, a Wi-Fi extender 126, an extender connected device 112, a downstream router connected device 114, and a direct connected device 106. In an example, the Wi-Fi extender 126 and the downstream routers 110 may be used to enhance the coverage and strength of a Wi-Fi network established by the LAN devices 108-1 to 108-3.

Further, the router 102 is communicably coupled to the user device 104 via Internet 116 and, to the plurality of customer premise equipment via a communication network (such as the second communication network 108-1). The Internet 116 is hereinafter interchangeably referred to as the Wide Area Network (WAN) 116. The router 102 may include the processor 118 and the memory 120 coupled to the processor 118 (as shown in FIG. 1A). The memory 120 includes processor-executable instructions, which on execution, cause the processor 118 to perform one or more operations described herein.

In one example, the customer premise may have a routed home network where a downstream router connected device 114 accesses the routed home network and a router (such as the downstream router 110) exists between the downstream router connected device 114 and the router 102. In this case the router 102 may have access to the IP address of the device (i.e., the LAN device 108-1).

The router 102 is typically managed by the server 122 and may provide status and statistics of the customer premise equipment upstream to the server 122. This enables a customer service agent 124 to access the aforementioned information during a customer service call or to the end-user via a website or an application that accesses the server 122. The provision of an enhanced set of device status and statistics is a key part of the present system. Alternatively, the router 102 may make the device status available to the customer or customer service agents 124 via web interface or cell or an application.

In one example, the router 102 may provide information related to the solution to the customer service agent 124 that allows expediting the isolation and diagnosis of the problem. Hence, the router 102 is configured to identify problems or issues to provide support (i.e., the troubleshooting solutions) for resolving the issues.

In particular, the router 102 utilizes a combination of the MAC address, hostname with accessed domain name history to identify and describe network devices (such as the customer premise equipment), LAN latency to identify Wi-Fi impairment, Wi-Fi signal quality (number of bars), and TCP packet loss to identify LAN impairment. To that effect, the troubleshooting solutions per device of the customer premise equipment are provided to the customer service agents 124 or the customer via the server 122 as explained above.

For troubleshooting purposes, the router 102 identifies a device (example, but not limited to the LAN device 108-1) based on device type, operating system, recent applications, and the like. The device type may include, but not limited to, computer, tablet, smart television (TV), streaming TV device, WAN extender, phone, and the like. For instance, if a customer is complaining about video buffering, the streaming video devices are identified, and a report on the device's LAN status may be generated.

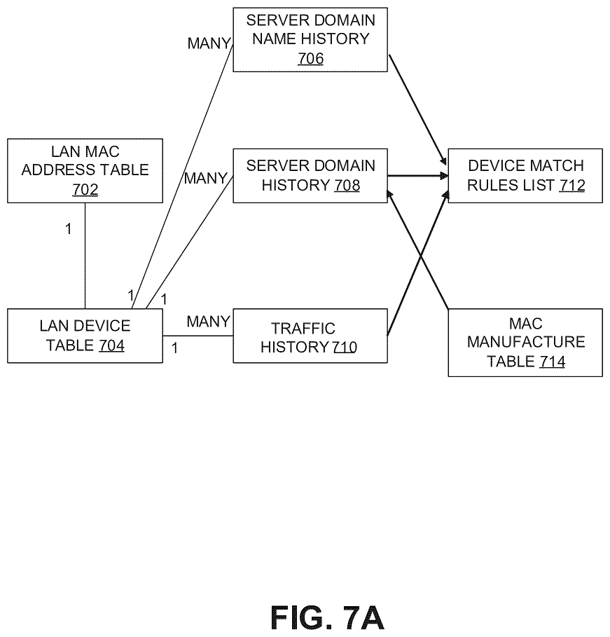

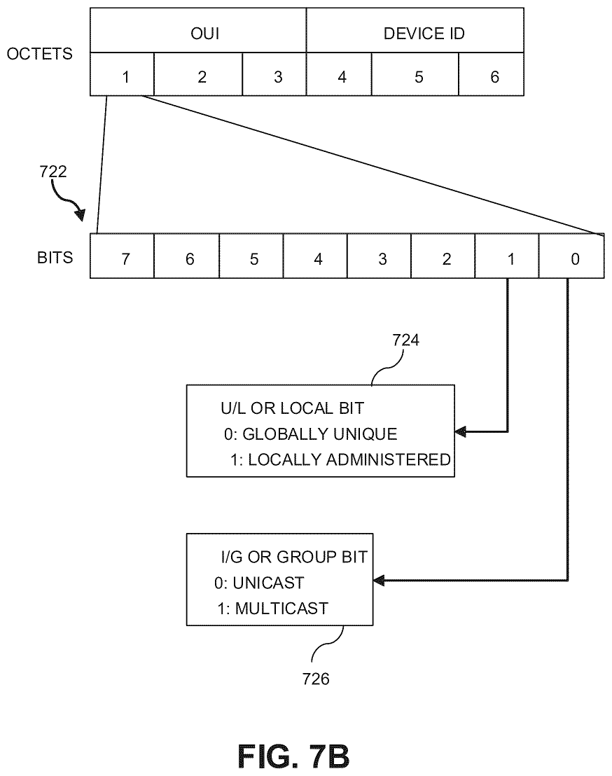

The router 102 may constantly identify (in real-time) data sources of the device (for example, the LAN device 108-1) associated with the issue as explained above. Typically, the device (for example, the LAN device 108-1) is identified based on the packet parameters and the device parameters. The device parameters may include a MAC Address. In general, a MAC address is a 6-byte address (as shown in block 720 of FIG. 7B) that is unique for all the devices within an Ethernet segment (as shown in FIG. 7B). Each packet sent by a LAN device (for example, the LAN device 108-1) on an Ethernet segment contains a unicast source MAC address (as shown in block 726 of FIG. 7B) and each packet sent individually to a LAN device (for example, the LAN device 108-1) contains the device's unicast destination MAC address (as shown in FIG. 7B). When a device (for example, the LAN device 108-1) is allocated with a locally administered MAC address (as shown in block 724 of FIG. 7B), the MAC address is used to identify the device type. Further, when a device (for example, the LAN device 108-1) is allocated with a globally unique address (as shown in block 724 of FIG. 7B), the remaining Organizationally Unique Identifier (OUI) bits may be used to do a table lookup to determine the manufacturer of the device (for example, the LAN device 108-1). The lookup may fail when the table covers the most popular devices or when a manufacturer bought a block of addresses after the table was finalized. Hence, the router 102 identifies the MAC address of the next hop downstream router in a packet of the downstream router connected device 114.

In one example, the router 102 may access the IP address to determine the device type of the device (for example, the LAN device 108-1). Typically, a device on a LAN uses the Dynamic Host Configuration Protocol (DHCP) protocol to obtain an IP address during startup and typically the DHCP server provides the same IP address to a device after the device is power cycled. Thus, the IP address may be used to identify a LAN device (for example, the LAN device 108-1).

In another example, the router 102 may access the hostname to identify the device associated with the issue. Generally, a device on a LAN may optionally provide, as part of using the DHCP protocol to obtain respective IP address, and a hostname (a character string). In some cases (for example, but not limited to, a LINUX laptop), the end-user may configure that hostname as part of device installation. In other cases, the device may create the hostname.

In another example, server domain names may be selected to identify the device associated with the issues. The server (for example, any server on the Internet 116) that a LAN device (such as the LAN device 108-1) communicates with may be used by a man-in-the-middle device (such as the router 102) as an input to identify the device. The server 122 on the Internet 116 is typically identified by the domain name. In some examples, ‘Company C’ devices currently access masks.ccc.com as part of providing privacy. A VPN is set up to masks.ccc.com and then no further domain names are visible to the router 102. A random MAC address may be used by the router 102. This is an example of how monitoring a device's accessed domain names becomes the best clue for identifying the device type.

Further, domain name system (DNS) lookups may be used to identify the device associated with the issues. A device (for example, the LAN device 108-1) may typically do a domain name lookup prior communicating with a server (i.e., the ISP server 122). A man-in-the middle device (such as the router 102) may monitor and collect the history of the servers looked up by a device where the unique device may be identified by the MAC address or the IP address.

In another example, a Transport Layer Security (TLS) or a Quick User Datagram Protocol (UDP) Internet Connections (QUIC) Protocol Client Hello Packet may be used to identify the device associated with the issues. In general, a device using the TLS protocol or QUIC protocol provide the server domain name that they intend to connect to in their CLIENT HELLO packet. Further, a man-in-the middle (such as the router 102) may monitor and collect the history of servers accessed by pulling the server name out of the Client Hello.

Further, upon identifying the device (for example, the LAN device 108-1) associated with the issues, the router 102 may determine the type of the device as explained above. For example, data structures may be used as a part of the monitoring of the LAN device packets and for identifying the type of the LAN device (for example, the LAN device 108-1).

In one scenario, the router 102 may utilize a LAN MAC Address table to identify the type of the LAN device. In the preferred example, the router 102 maintains a LAN MAC address table. The LAN MAC address table may be primarily keyed by the LAN device MAC address and entries of each LAN device MAC address identified by the router 102 as they monitor packets in upstream and downstream across the LAN device (for example, the LAN device 108-1) from and to the router 102. The table entry may include the list of downstream IP addresses that used that MAC address within the last N hours (for example 24 hours).

In another example, the router 102 may utilize a LAN device table to identify the type of the LAN device. Generally, each LAN Device table entry may include entries of server domain name history, server domain history entries, and traffic history. In the preferred example, the router 102 maintains a LAN device table that may be keyed by each LAN IP address identified by the router 102 as the router 102 monitors packets in upstream and downstream across the LAN device (for example, the LAN device 108-1) from and to the Router 102. Thus, one entry for each LAN device that sends packets to or from the Internet 116 may be stored in the LAN device table.

In another example, the router 102 may utilize a LAN IP address table to identify the type of the LAN device. In the preferred example, LAN IP Address Table entry may include entries related to whether the LAN MAC address is used by other IP addresses i.e., whether the device is a downstream router connected device, the manufacturer of the LAN MAC address, the history of server domain names accessed by the device. In the preferred example, the history automatically ages out server domain names older than a threshold (for example 24 hours). As described earlier, this history may be maintained by the router 102 monitoring the device's domain name lookups and/or TLS or QUIC session establishment packets, upstream and downstream traffic usage in bytes, device name, device description, a device status, and statistics.

In another example, the router 102 may utilize a device match rules list (i.e., the predefined device match rules) to identify the type of the LAN device (for example, the LAN device 108-1) and determine a status information and a performance information of the device (such as the LAN device 108-1). In an example, a device match rule is configured as a CSV (comma-separated) list of colon-separated Key-Value pairs where some keys are mandatory, and some are optional. The CSV fields may include an identification field. This field provides the alphanumeric plus ‘_’ character name of the device type. Further, the CSV field may include a description field. This field provides a description of the device type where the description uses ‘;’ in place of ‘,’ characters and uses ‘\hat{ }’ characters in place of ‘:’ characters. Furthermore, the CSV field may include a documentation field. This field provides a description of what kind of device this rule is intended to detect and the basics of how the rule works. For use by the developer of the rules and not provided by other parties. Further, the CSV field may include a domain_match_list field. This field A ‘;’ delimited list of server domains accessed by this device and scores where the domain and score are separated by an \hat{ } character. The domain portion of a fully qualified Domain Name is typically the last two fields of the Domain Name. For example, the domain from the fully qualified Domain Name www.abc.com is abc.com.

Furthermore, the CSV field may include a domain_no_match_list field. This field A ‘;’ delimited list of domains where the domain and score are separated by an ‘\hat{ }’ character and where the lack of a match to a domain in the list results in that domain's score being added to the rule's score. A domain's score is negative and used to penalize a device when this rule requires one or more of these domains.

Additionally, the CSV field may include a dns_match_list field where A ‘;’ delimited list of server domain names and where the domain and score are separated by an \hat{ } character. The CSV field may include min_num_domains where a \hat{ } character separated threshold and score and where the score is added when the number of domains exceeds the threshold. This match criteria may be used for identifying multi-use devices (for example, PCs, cellphones, and the like) which access many domains. Further, the CSV field may include max_num_domains field where a \hat{ } character separated threshold and score where the score is added when the number of domains is under the threshold. These match criteria are used for identifying single-use devices (for example doorbell cameras, home security equipment, and the like) which may not access many domains.

Further, the CSV field may include min_daily_byte_usage field where a \hat{ } character separated threshold and score and where the score is added when the average daily usage of a device exceeds the threshold. This match criteria are used for differentiating between active and idle devices.

Further, the CSV field may include max_daily_byte_usage field where a \hat{ } character separated threshold and score and where the score is added when the daily usage of a device falls below the thresholds. This match criteria are used for differentiating between active and idle devices.

Further, the CSV field may include a min_dnstream_percent field where a \hat{ } character separated threshold and score and where the score is added to the daily usage of a device whose percentage of downstream traffic exceeds this value. This criterion is used for identifying equipment such as streaming television (TV) devices whose traffic is nearly entirely download traffic.

Further, the CSV field may include a max_dnstream_percent field where a \hat{ } character separated threshold and score and where the score is added to the daily usage of a device whose percentage of downstream traffic falls below this value. This criterion is used for identifying equipment such as doorbell cameras or other telemetry type equipment whose traffic is nearly entirely upload traffic.

In an example, the router 102 may include the device match rules list and compare each LAN IP address table with the device match rules list to determine the device name and device description. In one example, the router 102 may implement a scoring mechanism to determine a matching rule with the highest resulting score and a device's identification and description. The rules are organized such that a set of unknown low-scoring rules may match any device. For instance, the highest score rule that matches from the device match rules list is equal to one of the unknown low-scoring rules. In other words, the highest score value is set to a value lower than any value in the device rules match list and with a device type and description that is the default value when no rule matches. In an example, a rule is defined to match any device and such a rule is assigned with the lowest score. In this example, the MAC address OUI table lookup vendor value and/or hostname is used as part of the identification of the device.

Further, the score for an individual rule is the sum of the score including but not limited to each domain in the domain history that matches a domain in the rule's domain_match_list taking the score from the matching domain_match_list entry, for each domain name in the domain name history that matches a domain name in the rule's dns_match_list taking the score from the matching dns_match_list entry, from the min_num_domains field when the rule has that field and when the domain history has at least this many domains, from the max_num_domains field when the rule has that field and when the domain history has this many or fewer domains, from the min_daily_byte_usage field when the rule has that field and when the daily usage is at least the field's threshold number of bytes, from the max_daily_byte_usage field when the rule has that field and when the daily usage is less than or equal to the field's threshold number of bytes, from the min_dnstream_percent field when the rule has that field and when the percentage of downstream traffic is at least the field's threshold value, from the max_dnstream_percent field when the rule has that field and when the percentage of downstream traffic is less than or equal to the field's threshold value.

The following is an example a few device match rules: name rule referring to unknown idle, a description rule for device whose type may not be detected with minimal usage, a min_num_domains rule for example, 1\hat{ }50000, a min_daily_byte_usage rule for example, 50000000\hat{ }-100000000, a documentation rule where the rule of thumb is that a positive identification of a device is required to have a score that exceeds 50000 that this unknown rule scores. The unknown device type is selected when no other rule has a higher score. Further, the device match rules include min_daily_byte_usage rule when exceeded indicates an active device.

A second example of device match rule may include name: unknown active, description, where a device whose type could not be detected with significant usage, min_num_domains: −1\hat{ }50000, max_daily_byte_usage: 50000000\hat{ }-100000000, and documentation. The rule of thumb is that a positive identification of a device should have a score of that exceeds the 50000 that this unknown rule scores. The unknown device type is selected when no other rule has a higher score. The max_daily_byte_usage when not exceeded indicates an idle device.

A third example of device match rule may include name: streaming video, description: a device whose type could not be detected with significant usage and streaming video, min_num_domains: −1\hat{ }50000, max_daily_byte_usage: 50000000\hat{ }-100000000, domain_match_list: ABC.com\hat{ }-10000000; ACME.com\hat{ }-10000000; ACMEtime.com\hat{ }-10000000; abc.com\hat{ }-10000000; box.com\hat{ }-10000000; windowsupdate.com\hat{ }-10000000; abctv.net \hat{ }2000; abc.tv\hat{ }2000; nflxvideo.net\hat{ }2000; movetv.com\hat{ }2000; aiv-cdn.net\hat{ }2000; abc.net\hat{ }1000; abc.com\hat{ }1000; plus.com.ssl.sc.omtrdc.net\hat{ }1000; stt.com\hat{ }1000; stt.com.akamaized.net\hat{ }1000, and documentation. This is the same as for an unknown active device except the score is boosted as it used known streaming video services.

A fourth example of device match rule may include name: ACME idle, description: A ACME streaming video device with little usage, domain_match_list: ACME.com\hat{ }600000; acmetime.com\hat{ }90000; ravm.tv\hat{ }50500, min_num_domains: 35\hat{ }-100000000, min_daily_byte_usage: 50000000\hat{ }-100000000, domain_no_match_list: acme.com\hat{ }-100000000, documentation. A device should be categorized as ACME if it has the acme domain match and not many domains. It is disqualified if there are too many domains or if the acme.com domain was not visited. min_daily_byte_usage when not exceeded indicates an idle device.

A fifth example of device match rule may include name: acme active, description. An ACME streaming video device that streamed significant video, domain_match_list: acme.com\hat{ }82000; acmetime.com\hat{ }90000; ravm.tv\hat{ }50500, max_daily_byte_usage: 50000000\hat{ }-100000000, max_dnstream_percent: 85\hat{ }-100000000, domain_no_match_list: acme.com\hat{ }-100000000, and documentation. A device should be categorized as ABC if it has the ABC domain match and not many domains. It is disqualified if there are too many domains or if the abc.com domain was not visited. The max_daily_byte_usage when not exceeded indicates an active device.

A sixth example of device match rule may include name: aaa idle, description. An aaa phone or tablet with little usage, dns_match_list: time.aaa.com\hat{ }82000, min_daily_byte_usage: 50000000\hat{ }-100000000, domain_no_match_list: aaa.com\hat{ }-100000000, documentation. The rule for an aaa phone or tablet is that it should be categorized as aaa if it has one or more of the specific aaa-related domain name matches. max_daily_byte_usage when not exceeded indicates an idle device.

A seventh example of device match rule may include name: XYZ active, description: A phone or tablet with significant usage, dns_match_list: time.XYZ.com\hat{ }61000, max_daily_byte_usage: 50000000\hat{ }-100000000, domain_no_match_list: XYZ.com\hat{ }-100000000, documentation. The rule for an XYZ phone or tablet is that it should be categorized as XYZ if it has one or more of the specific XYZ-related domain name matches. min_daily_byte_usage when exceeded indicates an active device.

An eight example of device match rule may include name: DEF or DEF active, description: A DEF device. There are other device types for DEF that are used. The dns_match_list: iosapps.abc.DEF.com\hat{ }100; time-ios.apple.com\hat{ }100; radioservices.itunes.apple.com\hat{ }100; guzzoni.DEF.com\hat{ }61800, max_daily_byte_usage: 50000000\hat{ }-100000000, domain_match_list: abc.com\hat{ }-10000000; acme.com\hat{ }-10000000; acmetime.com\hat{ }-10000000; abc.com\hat{ }-10000000; xboxlive.com\hat{ }-10000000; windowsupdate.com\hat{ }-10000000, domain_no_match_list: def.com\hat{ }-100000000, and documentation. The rule for a DEF device is based on server domain names accessed by that device. There will be rules for less specific devices.

A ninth example of device match rule may include name: winPC active, description: A xxx PC without clear markers of being an office PC, max_num_domains: 20\hat{ }-100000000,max_daily_byte_usage: 50000000\hat{ }-100000000,domain_match_list: windowsupdate.com\hat{ }51000; xxx.com\hat{ }10000; xxxonline.com\hat{ }10000; officexxx\hat{ }10000; office.net\hat{ }10000, dns_matchList:*delivery. mp.xxx.com\hat{ }51600; time.windows.com\hat{ }51500,documentation. A device is categorized as an XXX PC when it has a windows exclusive domain match and a decent number of domains. min_daily_byte_usage when not exceeded indicates an active device.

A tenth example of device match rule may include name: yyy smartTv active, description: A yyy smart TV with significant Internet usage, dns_match_list: images.visio.com\hat{ }28000; api.yyy.com\hat{ }28000; scfs.yyy.com\hat{ }28000; announcements.yyy.com\hat{ }28000; prod.cs.yyy.com\hat{ }28000, \max_daily_byte_usage: 50000000\hat{ }-100000000,\max_dnstream_percent: 85\hat{ }-100000000, documentation. The use of at least two specifics yyy.com server domain names categorize a device as a yyy smartTv. max_daily_byte_usage when not exceeded indicates an active device.

A tenth example of device match rule may include name: zzz doorbell active, description: A zzz.com video doorbell with significant Internet usage, dns_match_list: ps.zzz.com\hat{ }35000; iperf.zzz.com\hat{ }35000; es.ring.com\hat{ }35000; lpd.zzz.com\hat{ }35000; fw.zzz.com\hat{ }35000; ping.zzz.com\hat{ }35000, domain_match_list: zzz.solutions\hat{ }51000, max_daily_byte_usage: 10000000\hat{ }-100000000, documentation. The use of at least two specific ring doorbell server domain names categorizes a device as an zzz.com doorbell. The max_daily_byte_usage when not exceeded indicates an active device.

Additionally, the router 102 may utilize a MAC manufacturer table to identify the type of the LAN device and determine the status information and performance information of the device (such as the LAN device 108-1). The MAC manufacturer table may be keyed by the OUI bits from a MAC address and provides an entry for each of the MAC manufacturers that may be identified by the globally administered OUI. Each entry in the MAC manufacturer table includes the manufacturer's name and a description of their devices.

In an example, the router 102 is configured to monitor the status, signal quality measurement of the device, TCP packet loss measurement and LAN latency measurement of the device (for example, the LAN device 108-1).

The router 102 may be configured to monitor the signal quality of each device (for example, the LAN device 108—directly accessing the Wi-Fi and summarize that signal quality in the form of a set of bars. Further, the signal quality measurement may not be useful in some cases such as: when the device is extender or downstream router connected and the number of bars represents the signal quality from the Wi-Fi hop closest to the router 102 and thus provides no insight into connectivity downstream from that first hop. Further, the signal quality measurement may not be useful in some cases such as when one or more Wi-Fi hops are congested. Packet loss and latency may be used to identify this congestion. Further, the signal quality measurement may not be useful in some cases such as when a device is intermittently faulty the number of bars may be good despite the other faults, and when the device includes a wired LAN connection that may or may not have impairments.

The router 102 may measure a device's LAN latency by recording the time the device (for example, the LAN device 108-1) forwards a downstream packet that is ordinarily acknowledged and recording the time the upstream acknowledgement is received. The LAN round-trip time is the difference between the two times and is the measurement of LAN latency. The measurement of the device's latency may be performed on a subset of the candidate packets. Examples of downstream packets that are acknowledged include, but not limited to, TCP SYNACK packets where an TCP ACK is returned and TCP data packets where a TCP ACK is returned. In an example, a measure of LAN round-trip time is used to detect a device LAN impairment. The higher the latency above 20 millisecond (ms) results in the performance of the device (for example, the LAN device 108-1). Further, the router 102, for each device, records the number of round-trip latency measurements and the min, mean, and max value, for various timeframes (for example previous 60 seconds, previous 10 minutes, previous hour) in the device's LAN device table entry.

Further, the Router 102 may measure LAN downstream TCP packet loss by observing the TCP data packet transmitted in a later instance i.e., being transmitted a second time within a short period of time (for example, 200 ms) of its first transmission. The first transmission is in-sequence and includes the highest sequence number of the TCP connection's downstream packets. The second transmission represents a LAN lost packet. Further, monitoring the packet multiple times (for example, more than once) indicates that the packet is not lost upstream from the LAN. Occasionally a packet which is not lost may be retransmitted due to a timeout occurring. Typically, a lost packet is recovered by a FAST retransmit or SACK-triggered retransmission. Further, discounting retransmissions that are late filters out counting such retransmissions as LAN lost packets that may have been lost over the WAN.

Further, the LANs (such as the LAN device 108-1) typically deliver packets in sequence. The router 102 measures the LAN upstream TCP packet loss by monitoring the TCP an out-of-sequence upstream TCP packet with the highest sequence number yet observed for that TCP connection's upstream direction with a gap between that out-of-sequence packet and previous packet with the highest observed packet number. The number of packets in the gap is the number of lost packets. Furthermore, the router 102, for each device, records the number of upstream and downstream packets and lost packets (and the packet loss percentage), for various timeframes (for example previous 60 seconds, previous 10 minutes, previous hour) in the device's LAN device table entry.

The router 102 provides access to the LAN device status to the server 122 as explained above. For instance, access to the LAN device status is provided to the server 122 either on request from the server 122 and/or via periodic upload. Further, the one or more operations performed by the router 102 are similar to the operations performed by the router 102 or may be implemented by either of the router 102, hence they are not reiterated herein for the sake of brevity.

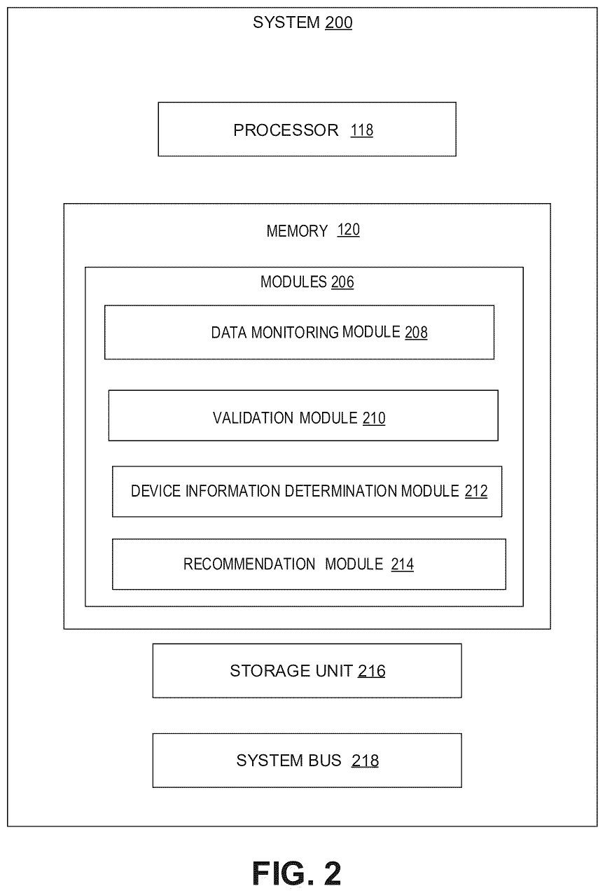

FIG. 2 illustrates an example block diagram representation of a system 200 (such as the router 102 as shown in FIG. 1A and FIG. 1B), in accordance with an example.

The system 200 may include a processor 118, and a memory 120. The memory 120 may include processor-executable instructions, which on execution, cause the processor 118 to perform one or more operations described herein. The memory 120 may include one or more modules 206. The modules 206 may include, but are not limited to, a data monitoring module 208, a validation module 210, a device information determination module 212, and a recommendation module 214. Each of these modules 206 (or the modules 208-214), when executed by the processor 118 performs one or more functionalities described in the context of the router 102. Execution of the machine-readable program instructions by the processor 118 may enable the system 200 to perform one or more functions. The “hardware” may include a combination of discrete components, an integrated circuit, an application-specific integrated circuit, a field programmable gate array, a digital signal processor, or other suitable hardware. The “software” may include one or more objects, agents, threads, lines of code, subroutines, separate software applications, two or more lines of code, or other suitable software structures operating in one or more software applications or on one or more processors.

The processor 118 may include, for example, microprocessors, microcomputers, microcontrollers, digital signal processors, central processing units, state machines, logic circuits, and/or any devices that manipulate data or signals based on operational instructions. Among other capabilities, the processor 118 may fetch and execute computer-readable instructions from a memory (not shown) operationally coupled with the system 200 for performing tasks such as data processing, input/output processing, attributes extraction, and/or any other functions. Any reference to a task in the present disclosure may refer to an operation being, or that may be, performed on data or input information.

For example, the data monitoring module 208 monitors data packets communicated between the WAN (for example, the WAN 116) and the plurality of customer premise equipment (such as the customer premise equipment) during the upstream transmission and the downstream transmission.

Further, the data monitoring module 208 determines the plurality of packet parameters associated with the monitored data packets and the plurality of device parameters associated with the plurality of customer premise equipment based on the monitored data packets. Thereafter, the validation module 210 validates the determined plurality of packet parameters and the plurality of device parameters based on the predefined device match rules. In particular, the validation module 210 implements the scoring mechanism to identify the device associated with the issue, as explained above. Further, the validation module 210 identifies the customer premise equipment (for example, the LAN device 108-1) along with the plurality of characteristics from the plurality of customer premise equipment based on results of the validation. The plurality of characteristics may include, for example, but not limited to, the device type, the device name, and the device description.

The device information determination module 212 determines the status information and the performance information associated with the identified customer premise equipment (for example, the LAN device 108-1) based on the determined plurality of characteristics and the predefined device match rules. The performance information may include the device network latency measurement and the packet loss measurements. The device information determination module 212 further determines the at least one issue associated with the identified customer premise equipment (the LAN device 108-1) based on the determined status information and the performance information.

The recommendation module 214 generates the plurality of recommendations corresponding to the determined at least one issue based on pre-stored rules. The generated plurality of recommendations includes the troubleshooting solutions for the determined at least one issue. Thereafter, the recommendation module 214 transmits the generated plurality of recommendations to at least one of the plurality of user devices 104-1 to 104-N and the server 122 managing the router 102.

The storage unit 216 may store, but is not limited to, LAN device tables, issue table, predefined device match rules, MAC address, pre-stored device parameters, pre-stored packet parameters, plurality of characteristics, an acknowledgement (ACK) time of downstream transmission control protocol (TCP) data packet, an upstream and a downstream packet loss, a destination Internet Protocol (IP) address, a server domain and a server domain name, a server domain history and a server domain name history, a packet size, a TCP retransmission information, and a TCP out-of-sequence packet reception, a round-trip latency, a Media Access Control (MAC) address, IP address, a domain history, a domain name history, a data traffic history, a maximum daily byte usage, a minimum daily byte usage, a maximum number of domains, a minimum number of domains, a minimum downstream percentage, a maximum downstream percentage, a device IP address, device statistics, a device manufacturer name, a TCP connection establishment information, a TCP segment acknowledgement latency, a LAN congestion, a device network connectivity, device downstream traffic information, device traffic history table, device network latency measurement and packet loss measurements, pre-stored rules, a server domain name history, a server domain history, a traffic history, and a MAC manufacturer information, pre-set threshold values, historical device data and the like. The storage unit 216 may be any kind of database such as, but are not limited to, relational databases, dedicated databases, dynamic databases, monetized databases, scalable databases, cloud databases, distributed databases, any other databases, and a combination thereof.

The system bus 218 may interconnect various subsystems, elements, and/or components of the router 102. As shown, the interconnect may be an abstraction that may represent any one or more separate physical buses, point-to-point connections, or both, connected by appropriate bridges, adapters, or controllers. In some examples, the interconnect may include a system bus, a peripheral component interconnect (PCI) bus or PCI-Express bus, or a Hyper Transport or industry standard architecture (ISA)) bus, a small computer system interface (SCSI) bus, a universal serial bus (USB), an IIC (I2C) bus, or an Institute of Electrical and Electronics Engineers (IEEE) standard 1394 bus, or “firewire,” or other similar interconnection element.

In some examples, the system bus 218 may allow data communication between the processor 118 and system memory 120, which may include read-only memory (ROM) or flash memory (neither shown), and random-access memory (RAM). It should be appreciated that the RAM may be the main memory into which an operating system and various application programs may be loaded. The ROM or flash memory may contain, among other code, the Basic Input-Output system (BIOS) which controls basic hardware operations such as the interaction with one or more peripheral components.

The processor 118 may be the central processing unit (CPU) of the computing device and may control the overall operation of the computing device. In some examples, the processor 118 may accomplish this by executing software or firmware stored in system memory or other data via the storage. The processor 118 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter (not shown in FIG. 2) may connect to various multimedia elements or peripherals. These may include a device associated with visual (for example, video card or display), audio (example, sound card or speakers), and/or various input/output interfaces (example, mouse, keyboard, touchscreen).

The network communicator (not shown) may provide the computing device with an ability to communicate with a variety of remove devices over a network and may include, for example, an Ethernet adapter, a Fiber Channel adapter, and/or another wired- or wireless-enabled adapter. The network communicator may provide a direct or indirect connection from one network element to another and facilitate communication between various network elements.

The storage unit 216 may connect to a standard computer-readable medium for storage and/or retrieval of information, such as a fixed disk drive (internal or external).

Many other devices, components, elements, or subsystems (not shown) may be connected in a similar manner to the interconnect or via a network. Code or computer-readable instructions to implement the dynamic approaches for payment gateway selection and payment transaction processing of the systems and methods may be stored in computer-readable storage media such as one or more of system memory or other storage. Code or computer-readable instructions to implement the dynamic approaches for payment gateway selection and payment transaction processing of the systems and methods may also be received via one or more interfaces and stored in memory.

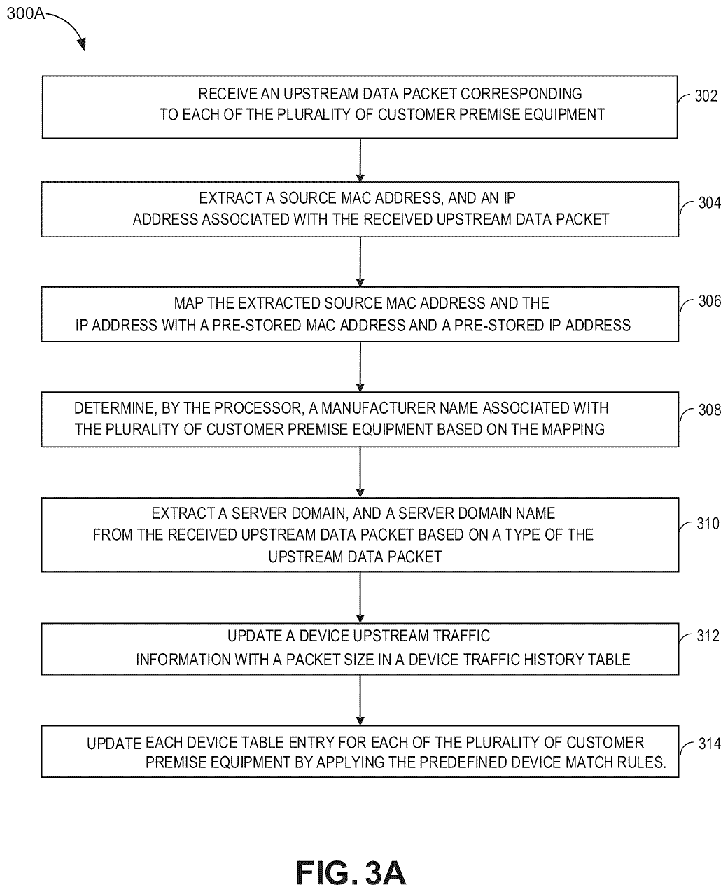

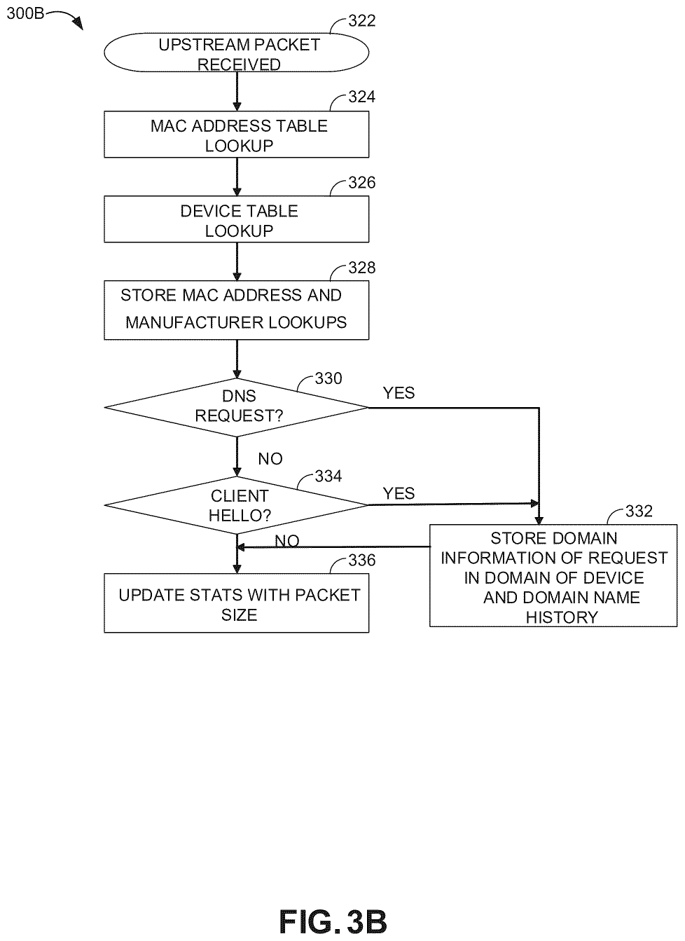

FIG. 3A illustrates an example flow diagram representation of a method 300A for monitoring upstream transmission, according to an example. The disclosed method 300A may be performed by one or more components of the router 102 disclosed herein. At block 302, the method 300A includes receiving, by the processor 118, the upstream data packet corresponding to each of the plurality of customer premise equipment. At block 304, the method 300A includes extracting, by the processor 118, the source MAC address, and the IP address associated with the received upstream data packet.

At block 306, the method 300A includes mapping, by the processor 118, the extracted source MAC address and the IP address with the pre-stored MAC address and the pre-stored IP address.

At block 308, the method 300A includes determining, by the processor 118, the manufacturer name associated with the plurality of customer premise equipment based on the mapping.

At block 310, the method 300A includes extracting, by the processor 118, the server domain, and the server domain name from the received upstream data packet based on the type of the upstream data packet.

At block 312, the method 300A includes updating, by the processor 118, the device upstream traffic information with the packet size in the device traffic history table.

At block 314, the method 300A includes updating, by the processor 118, each device table entry for each of the plurality of customer premise equipment by applying the predefined device match rules. The one or more operations related to monitoring the upstream data transmission are explained with references to FIGS. 1A-1B and FIG. 2, therefore they are not reiterated herein for the sake of brevity.

FIG. 3B illustrates an example flow diagram of a method 300B for monitoring upstream data transmission, according to an example. The disclosed method 300B may be performed by one or more components of the router 102.

At block 322, the method 300B includes monitoring, by the processor 118, if an upstream packet is received at the router 102. The upstream packet may include an Ethernet header and IP packet for upstream packet monitoring. This may occur either in real-time with the reception of the upstream packet or by queuing up the packet (or a copy of the packet) for background processing.

At block 324, the method 300B includes looking up, by the processor 118, the LAN MAC address table. The upstream packet's source MAC address is used to lookup the MAC address in the LAN MAC address table. Further, a new entry is created in the LAN MAC address table if the MAC address is not present. Furthermore, the entries in the LAN MAC address table may be aged out if not used recently (for example, 24 hours). The source IP address from the upstream packet is added to the LAN MAC address table.

At block 326, the method 300B includes performing, by the processor 118, the LAN Device table lookup. The upstream packet's source IP address is used to lookup an entry in the LAN device table. Further, a new entry is created in the LAN device table if the source IP address is not present. Furthermore, the entries in the LAN device table may be aged out if not used recently (for example, 24 hours).

At block 328, the method 300B includes storing, by the processor 118 the MAC address and manufacturer lookup. In particular, when a new device table entry is created, the MAC address of the device is stored in the LAN device table entry along with the results of the MAC manufacturer table lookup.

At block 330, the method 300B includes checking, by the processor 118 a domain name system (DNS) Request. Specifically, the processor 118 monitors the upstream packet to determine whether the packet is the DNS request.

At block 332, the method 300B includes storing, by the processor 118, the request's domain data in device's domain and domain name history if the upstream packet is the DNS request.

At block 334, the method 300B includes checking, by the processor 118, if the upstream packet is a client hello packet if the packet is not the DNS request. Upon determining the upstream packet is the Client hello packet, step 332 is performed.

At block 336, the method 300B includes updating, by the processor 118, the statistics with the packet size. In particular, the device table's traffic history's upstream traffic information is updated with the size of the packet.

Further, the processor 118 may check the time for the identification of the device (for example, the LAN device 108-1) update. Based on the time, the processor 118 applies device match rules to the LAN device table entry for identifying the device (for example, the LAN device 108-1). Alternatively, the processor 118 may update the device ID based on a packet count.

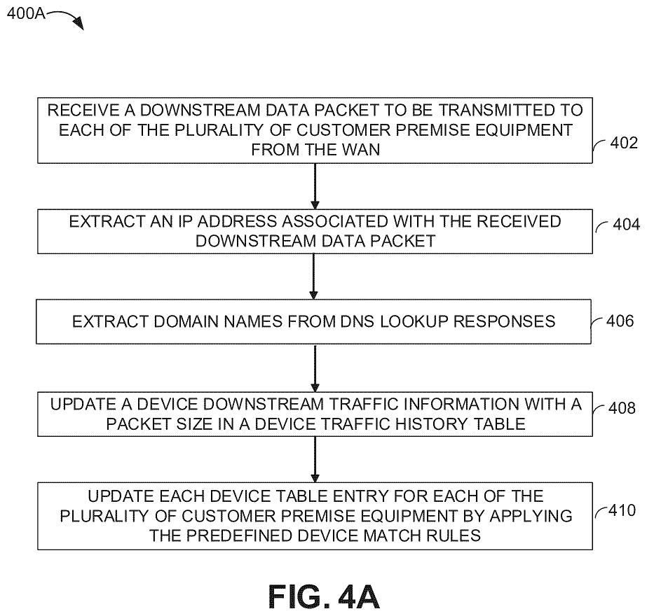

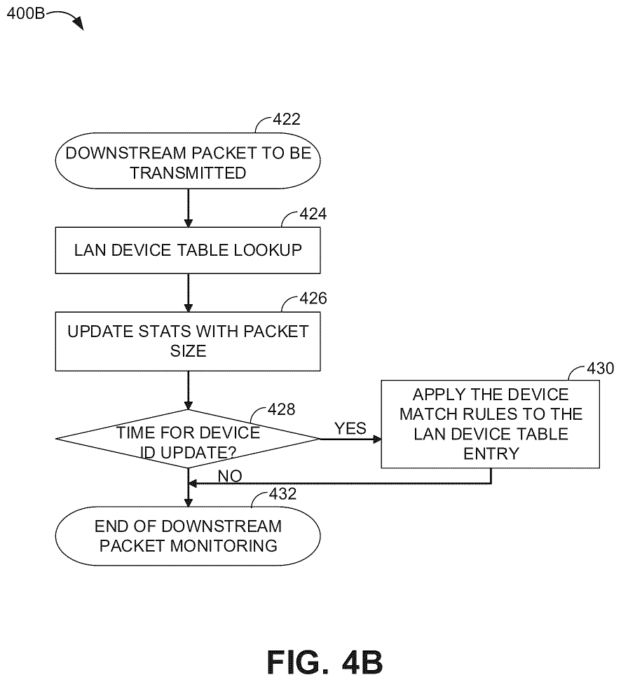

FIG. 4A illustrates an example flow diagram representation of a method 400A for monitoring downstream transmission, according to an example. The disclosed method 400a may be performed by one or more components of the router 102 disclosed herein.

At block 402, the method 400a includes receiving, by the processor (such as the processor 118), the downstream data packet to be transmitted to each of the plurality of customer premise equipment from the WAN (for example, the WAN 116).

At block 404, the method 400a includes extracting, by the processor 118, the IP address associated with the received downstream data packet.

At block 406, the method 400a includes extracting, by the processor 118, domain names from DNS lookup responses.

At block 408, the method 400a includes updating, by the processor 118, the device downstream traffic information with the packet size in the device traffic history table.

At block 410, the method 400a includes updating, by the processor 118, each device table entry for each of the plurality of customer premise equipment by applying the predefined device match rules. The one or more operations related to monitoring the downstream data transmission are explained with references to FIGS. 1A-1B and FIG. 2, therefore they are not reiterated herein for the sake of brevity.

FIG. 4B illustrates an example flow diagram representation of a method 400B for monitoring downstream transmission, according to an example. The disclosed method 400B may be performed by one or more components of the router 102 disclosed herein.

At block 422, the method 400B includes monitoring, by the processor 118, the downstream packet to be transmitted. The downstream packet includes an Ethernet header to enable downstream packet monitoring. This may occur either in real-time with the transmission of the downstream packet or by queuing up the downstream packet (or a copy of the downstream packet) for background processing.

At block 424, the method 400B includes performing, by the processor 118, the LAN device table lookup. The downstream packet's destination IP address is used to lookup an entry in the LAN device table.

At block 426, the method 400B includes updating, by the processor 118, the statistics with the packet size. Specifically, the device table's traffic history's downstream traffic information is updated with the size of the downstream packet.

At block 428, the method 400B includes checking, by the processor 118, for the time of the device (for example, the LAN device 108-1). At block 430, the method 400b includes applying, by the processor 118, device match rules to the LAN device table entry. At block 432, the method 400B includes terminating, by the processor 118, the downstream packet monitoring.

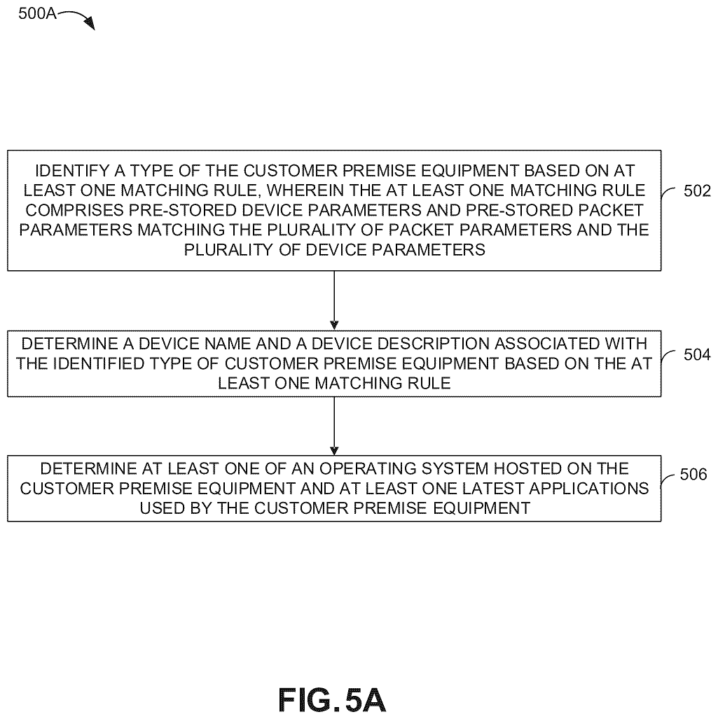

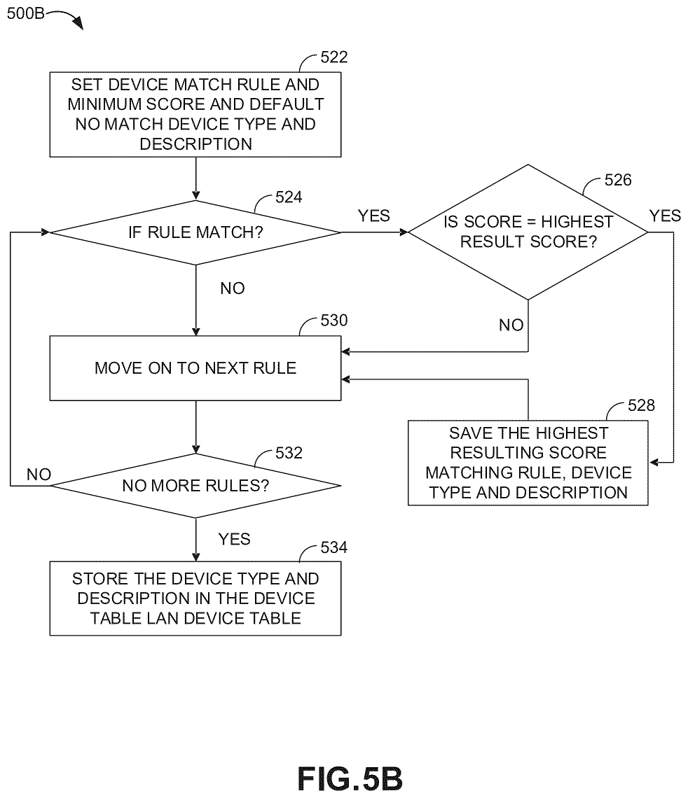

FIG. 5A illustrates an example flow diagram representation of a method 500A for identifying the customer premise equipment along with the plurality of characteristics from the plurality of customer premise equipment based on the results of validation, according to an example. The disclosed method 500A may be performed by one or more components of the router 102 disclosed herein.

At block 502, the method 500A includes identifying, by the processor (such as the processor 118), the type of the customer premise equipment (for example, the LAN device 108-1) based on the at least one matching rule. The at least one matching rule may include pre-stored device parameters and pre-stored packet parameters matching the plurality of packet parameters and the plurality of device parameters.

At block 504, the method 500A includes determining, by the processor 118, the device name and the device description associated with the identified type of customer premise equipment (for example, the LAN device 108-1) based on the at least one matching rule.

At block 506, the method 500A includes determining, by the processor 118, the at least one of an operating system hosted on the customer premise equipment (for example, the LAN device 108-1) and at least one latest applications used by the customer premise equipment (for example, the LAN device 108-1) based on recent (for example, one hour) domain name lookups. The one or more operations related to identifying the customer premise equipment along with the plurality of characteristics are explained with references to FIGS. 1A-1B and FIG. 2, therefore they are not reiterated herein for the sake of brevity.

FIG. 5B illustrates an example flow diagram representation of a method 500B for determining the device (for example, the LAN device 108-1) type and description, according to an example. The disclosed method 500B may be performed by one or more components of the router 102 disclosed herein.

At block 522, the method 500A includes setting, by the processor 118, the highest resulting score value to a value lower than any value in the predefined device match rules. Further, a device type and description are defined for each rule or when no rule matches from the predefined match rules.

At block 524, the method 500B includes determining, by the processor 118, if a rule matches the device's (for example, the LAN device 108-1) status and statistics (including domain history, domain name history and traffic history) based on the predefined device match rules.

At block 526, if the rule is determined from the predefined device match rules, the method 500B includes determining, by the processor 118, whether the rule's score is the highest resulting score. In case, the rule is not determined from the predefined device and the score is not equivalent to the highest resulting score, step 530 is performed. At block 530, the method 500B includes checking, by the processor 118, for subsequent rule in the predefined device match rules.

At block 528, the method 500B includes storing, by the processor 118, the rule as the highest resulting score, and device type and description of the device (for example, the LAN device 108-1). Upon storing, the method 500B includes performing, by the processor 118, the step 530.

At block 532, the method 500B includes determining, by the processor 118, if all the rules of the predefined device match rules are checked. If not, the method 500B includes repeating, by the processor 118 the steps 524-530. In case, all the rules of the predefined device match rules are checked, the processor 118 stores the device type and device description in the LAN device table (see, step 534 of FIG. 5B). For example, the process begins with a highest score value set to a value lower than any value in the match table and with a device type and description that is the default value when no rule matches. In the preferred example, there is a rule which is guaranteed to match any device and it has the lowest score. Then it is determined if the rule matches the device's status and statistics (including its domain history, domain name history, and traffic history) and then determines whether the rule's score is the highest seen. If yes, the rule becomes the basis for the “matching” score, device type, and description. When all the rules have been examined, the device Table Entry's device type and device description are filled with the matching device type and description. This rule matching is one example of the implementation of identifying the device, although, a person skilled in the art may envision that there could be other matching type algorithms implemented to identify the device. It is to be noted that the Wi-Fi extender 126 and the downstream routers 110 may be used to enhance the coverage and strength of a Wi-Fi network established by the LAN devices 108-1 to 108-3.

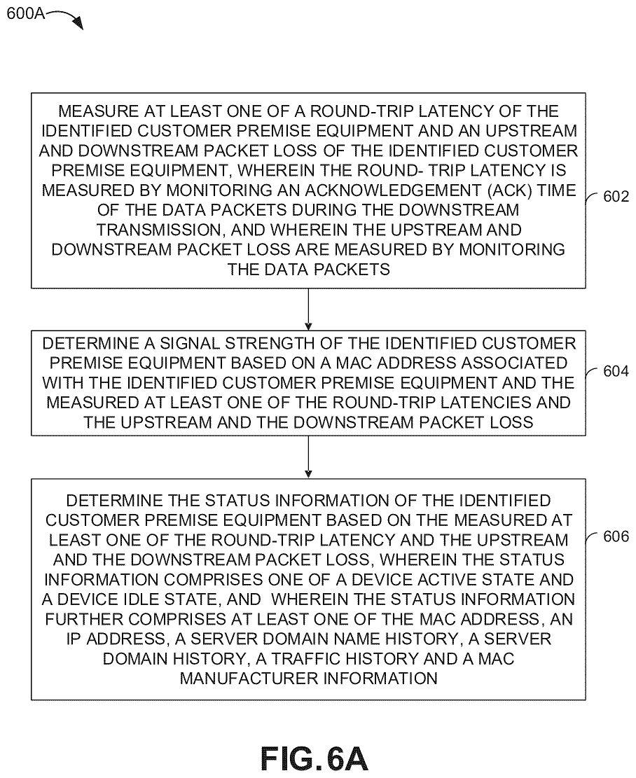

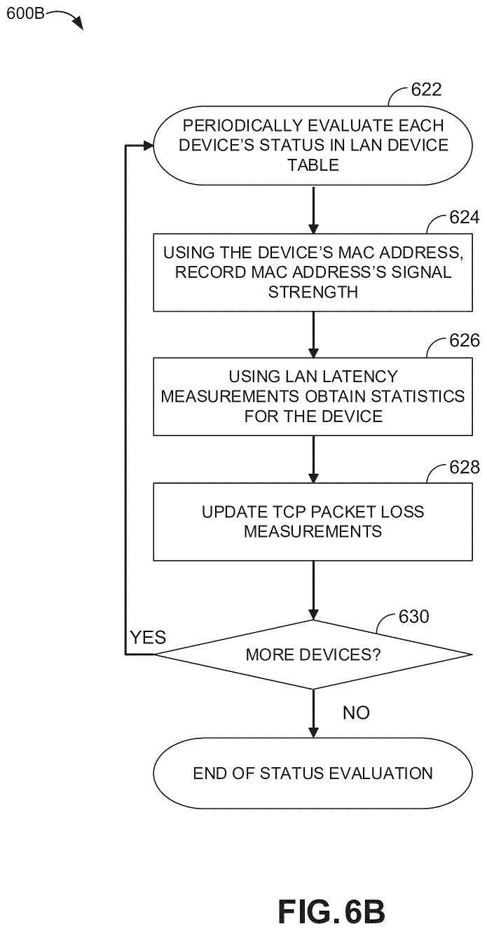

FIG. 6A illustrates an example flow diagram representation of a method 600A for determining the status information and the performance information associated with the identified customer premise equipment (for example, the LAN device 108-1), according to an example. The disclosed method 600A may be performed by one or more components of the router 102 disclosed herein.

At block 602, the method 600A includes measuring, by the processor (such as the processor 118) the at least one of a round-trip latency of the identified customer premise equipment (for example, the LAN device 108-1) and the upstream and downstream packet loss of the identified customer premise equipment (for example, the LAN device 108-1). The round-trip latency is measured by monitoring an acknowledgement (ACK) time of the data packets during the downstream transmission. The upstream and downstream packet loss are measured by monitoring the data packets.

At block 604, the method 600A includes determining, by the processor 118 the signal strength of the identified customer premise equipment (for example, the LAN device 108-1) based on the MAC address associated with the identified customer premise equipment (for example, the LAN device 108-1) and the measured at least one of the round-trip latencies and the upstream and the downstream packet loss.

At block 606, the method 600A includes determining, by the processor 118, the status information of the identified customer premise equipment (for example, the LAN device 108-1) based on the measured at least one of the round-trip latency and the upstream and the downstream packet loss. The status information may include one of a device active state and a device idle state. The status information further includes at least one of the MAC address, the IP address, the server domain name history, the server domain history, the traffic history, and the MAC manufacturer information. The one or more operations related to determining the status information and the performance information associated with the identified customer premise equipment are explained with references to FIGS. 1A-1B and FIG. 2, therefore they are not reiterated herein for the sake of brevity.

FIG. 6B illustrates an example flow diagram representation of a method 600B for determining the status information and the performance information associated with the identified customer premise equipment (for example, the LAN device 108-1), according to an example. The disclosed method 600B may be performed by one or more components of the router 102 disclosed herein.

At block 622, the method 600B includes periodically evaluating, by the processor 118, each device's (for example, the LAN device 108-1) status of the LAN device table.

At block 624, the method 600B includes recording, by the processor 118, the MAC address signal strength of each device (for example, the LAN device 108-1) based on the device's (for example, the LAN device 108-1) MAC address.

At block 626, the method 600B includes obtaining, by the processor 118, the statistics for the device (for example, the LAN device 108-1) using LAN latency measurements.

At block 628, the method 600B includes updating, by the processor 118, the TCP packet loss measurements based on the statistics of the device (for example, the LAN device 108-1).

At block 630, the method 600B includes checking, by the processor 118, if any devices are available to determine the status. In case no devices are available, the method 600B includes terminating, by the processor 118, the status evaluation process. In case the devices are available, the method 600B includes repeating, by the processor 118 the steps 622-630.

FIG. 7A illustrates an example block diagram representation 700A of device status monitoring data structures, according to an example. As shown, the device status monitoring data structures include a LAN MAC Address table 702, a LAN device table 704, a device match rules list 712, and a MAC manufacturer table 714. Further, the LAN device table 704 may include a server domain name history 706, a server domain history 708, and a traffic history 710.

The LAN MAC Address table 702 may be used to identify the type of the LAN device. The LAN MAC address table 702 may be primarily keyed by the LAN device MAC address and entries of each LAN device MAC address identified by the router 102 as it monitors packets in upstream and downstream across the LAN device (for example, the LAN device 108-1) from and to the router 102. The table entry of the LAN MAC address table 702 may include the list of downstream IP addresses that used that MAC address within the last N hours (for example 24 hours). Further, the LAN MAC address table 702 may include a list of LAN IP addresses.

The LAN device table 704 may be used to identify the type of the LAN device. Generally, each entry in the LAN device table 704 may include entries of the server domain name history 706, the server domain history 708, and the traffic history 710. The LAN device table 704 may be keyed by each LAN IP address identified by the router 102 as the router 102 monitors packets upstream and downstream across the LAN device from and to the Router 102. Thus, one entry for each LAN device that sends packets to or from the Internet may be stored in the LAN device table 704.

The device match rules list 712 (i.e., the predefined device match rules) may be used to identify the type of the LAN device and determine the status information and performance information of the device (such as the LAN device 108-1). In an example, the router 102 may include the device match rules list and periodically compare each LAN IP address table with the device match rules list to determine the device name and device description. In an example, the router 102 may implement a scoring mechanism to determine a matching rule with the highest resulting score and a device's identification and description. The rules are organized so that a set of unknown low-scoring rules may match any device. For instance, the highest score rule that matches from the device match rules list is equal to one of the unknown low-scoring rules. In other words, the highest score value is set to a value lower than any value in the device rules match list and with a device type and description that is the default value when no rule matches. In an example, a rule is defined to match any device and such a rule is assigned with the lowest score. In this example, the MAC address OUI table lookup vendor value and/or hostname is used as part of the identification of the device. Alternatively, other matching type algorithms may be used to identify the device (such as the LAN device 108-1) based on the associated data of the device as explained above.

The MAC manufacturer table 714 may be used to identify the type of the LAN device and determine the status and performance information of the device (such as the LAN device 108-1). The MAC manufacturer table 714 may be keyed by the OUI bits from a MAC address and provides an entry for each of the MAC manufacturers that may be identified by the globally administered OUI. Each entry in the MAC manufacturer table 714 includes the manufacturer's name and a description of their devices.

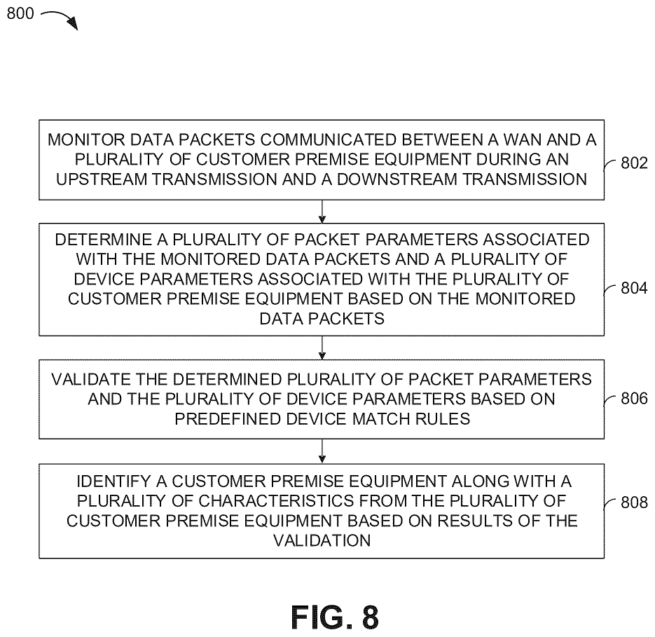

FIG. 8 illustrates an example flow diagram representation of a method 800 for providing troubleshooting solutions for network related issues, according to an example. The disclosed method 800 may be performed by one or more components of the router 102 disclosed herein.

At block 802, the method 800 includes monitoring, by the processor 118, data packets communicated between the WAN 116 and the plurality of customer premise equipment during the upstream transmission and the downstream transmission.

At block 804, the method 800 includes determining, by the processor 118, the plurality of packet parameters associated with the monitored data packets and the plurality of device parameters associated with the plurality of customer premise equipment based on the monitored data packets.

At block 806, the method 800 includes validating, by the processor 118, the determined plurality of packet parameters and the plurality of device parameters based on predefined device match rules.

At block 808, the method 800 includes identifying, by the processor 118, the customer premise equipment (for example, the LAN device 108-1) along with a plurality of characteristics from the plurality of customer premise equipment based on results of validation. The plurality of characteristics includes the device type, the device name, and the device description.

Additionally, the processor 118 may determine the status information and the performance information associated with the identified customer premise equipment (for example, the LAN device 108-1) based on the determined plurality of characteristics and the predefined device match rules. The performance information comprises a device network latency measurement and packet loss measurements. Further, the processor 118 may determine the at least one issue associated with the identified customer premise equipment (for example, the LAN device 108-1) based on the determined status information and the performance information. The processor 118 may further generate the plurality of recommendations corresponding to the determined at least one issue based on pre-stored rules. The generated plurality of recommendations includes the plurality of troubleshooting solutions for the determined at least one issue. The processor 118 may transmit the generated plurality of recommendations to at least one of the plurality of user devices (for example, the user devices 104-1 to 104-N) and the server (such as the server 122) managing the router 102.

The order in which the method 800 is described is not intended to be construed as a limitation, and any number of the described method blocks may be combined or otherwise performed in any order to implement the method 800 or an alternate method. Additionally, individual blocks may be deleted from the method 800 without departing from the spirit and scope of the ongoing description. Furthermore, the method 800 may be implemented in any suitable hardware, software, firmware, or a combination thereof, that exists in the related art or that is later developed. The method 800 describes, without limitation, the implementation of the router 102. A person of skill in the art will understand that method 800 may be modified appropriately for implementation in various manners without departing from the scope and spirit of the ongoing description. Further, the one or more operations related to providing troubleshooting solutions for network related issues at the customer premise are explained with references to FIGS. 1A-1B to FIG. 7, therefore they are not reiterated herein for the sake of brevity.

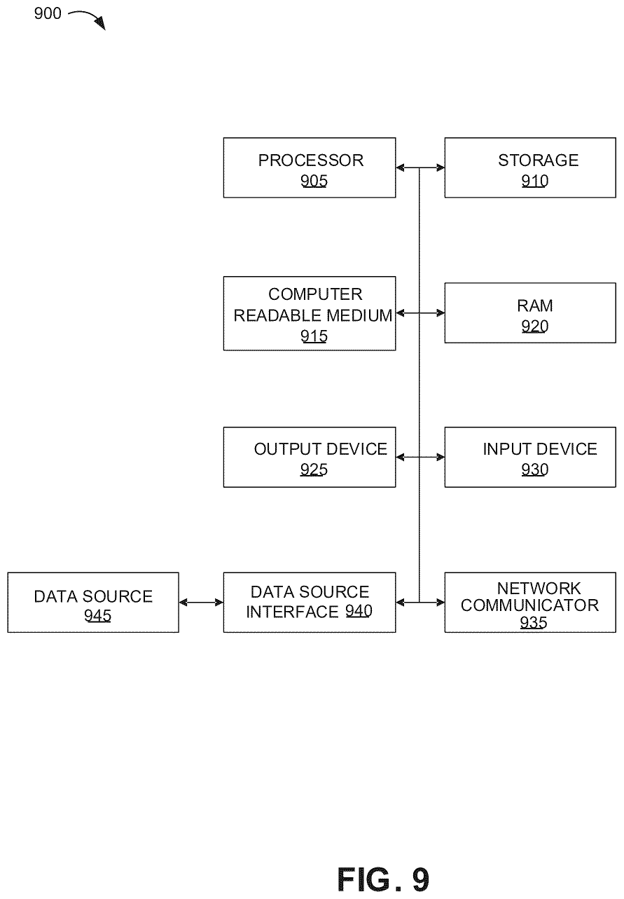

FIG. 9 illustrates an example block diagram representation of a computer system 900, according to an example. The computer system 900 may be part of or any one of the router 102, as shown in the network architecture 100A or the network architecture 100B to perform the functions and features described herein. The computer system 900 may include, among other things, an interconnect 910, a processor 905, a storage 910, a computer readable medium 915, a RAM 920, an output device 925, an input device 930, a data source 945, a data source interface 940, and a network communicator 935,

The interconnect (not shown in FIG. 9) may interconnect various subsystems, elements, and/or components of the computer system 900. As shown, the interconnect may be an abstraction that may represent any one or more separate physical buses, point-to-point connections, or both, connected by appropriate bridges, adapters, or controllers. In some examples, the interconnect may include a system bus, a peripheral component interconnect (PCI) bus or PCI-Express bus, a Hyper Transport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect may allow data communication between the processor 905 and system memory, which may include read-only memory (ROM) or flash memory (neither shown), and random-access memory (RAM) 920. It should be appreciated that the RAM 920 may be the main memory into which an operating system and various application programs may be loaded. The ROM or flash memory may contain, among other code, the Basic Input-Output system (BIOS) which controls basic hardware operations such as the interaction with one or more peripheral components.

The processor 905 may be the central processing unit (CPU) of the computing device and may control the overall operation of the computing device. In some examples, the processor 905 may accomplish this by executing software or firmware stored in system memory or other data via the storage 910. The processor 905 may be or may include, one or more programmable general-purpose or special-purpose microprocessors, digital signal processors (DSPs), programmable controllers, application-specific integrated circuits (ASICs), programmable logic devices (PLDs), trust platform modules (TPMs), field-programmable gate arrays (FPGAs), other processing circuits, or a combination of these and other devices.

The multimedia adapter (not shown in FIG. 9) may connect to various multimedia elements or peripherals. These may include a device associated with visual (for example, video card or display), audio (example, sound card or speakers), and/or various input/output interfaces (example, mouse, keyboard, touchscreen).

The network communicator 935 may provide the computing device with the ability to communicate with a variety of remote devices over a network and may include, for example, an Ethernet adapter, a Fiber Channel adapter, and/or another wired- or wireless-enabled adapter. The network communicator 935 may provide a direct or indirect connection from one network element to another and facilitate communication between various network elements.

The storage 910 may connect to a standard computer-readable medium for storage and/or retrieval of information, such as a fixed disk drive (internal or external).

The present disclosure provides a system and method where the set of domains accessed by a LAN device is evaluated against a set of known device types to produce a hassle-free identification of the device. The amount of data being handled is evaluated. Further, the relative amount of downstream data for the device is evaluated. Furthermore, a system and method evaluate the status of a LAN device by an edge router measuring the device's LAN round-trip latency. The round-trip latency is measured by monitoring the ACK time of a subset of the device's downstream TCP data packets. The system and method evaluate the status of a LAN device by an edge router measuring the device's LAN upstream and downstream packet loss as measured by monitoring a subset of the device's TCP packets.

Many other devices, components, elements, or subsystems (not shown) may be connected in a similar manner to the interconnect or via a network. Code or computer-readable instructions to implement the dynamic approaches for payment gateway selection and payment transaction processing of the systems and methods may be stored in computer-readable storage media such as one or more of system memory or other storage. Code or computer-readable instructions to implement the dynamic approaches for payment gateway selection and payment transaction processing of the systems and methods may also be received via one or more interfaces and stored in memory.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing network communication.

It should also be appreciated that the systems and methods, as described herein, may also include, or communicate with, other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more applications that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

Although examples are directed to satellite communication systems, such as high throughput satellite (HTS) systems, it should be appreciated that the systems and methods described herein may also be used in other various systems and other implementations. For example, these may include other various telecommunication tests and measurement systems. In fact, there may be numerous applications in cable or optical communication networks, not to mention fiber sensor systems that could employ the systems and methods as well.

It should be appreciated that the systems and methods described herein may also be used to help provide, directly or indirectly, measurements for distance, angle, rotation, speed, position, wavelength, transmissivity, and/or other related tests and measurements.

What has been described and illustrated herein are examples of the implementation along with some variations. The terms, descriptions, and figures used herein are set forth by way of illustration and are not meant as limitations. Many variations are possible within the scope of the implementations, which are intended to be defined by the following claims—and their equivalents—in which all terms are meant in their broadest reasonable sense unless otherwise indicated.

1. A router, comprising:
a processor; and
a memory coupled to the processor, wherein the memory includes processor-executable instructions, which on execution, cause the processor to:
monitor data packets communicated between a wide area network (WAN) and a plurality of customer premise equipment during an upstream transmission and a downstream transmission;
determine a plurality of packet parameters associated with the monitored data packets and a plurality of device parameters associated with the plurality of customer premise equipment based on the monitored data packets;
validate the plurality of packet parameters and the plurality of device parameters based on predefined device match rules; and
identify a customer premise equipment along with a plurality of characteristics from the plurality of customer premise equipment based on results of validation, wherein the plurality of characteristics comprise a device type, a device name, and a device description.

2. The router of claim 1, wherein the plurality of packet parameters comprise an acknowledgement (ACK) time of downstream transmission control protocol (TCP) data packet, an upstream and a downstream packet loss, a destination Internet Protocol (IP) address, a server domain and a server domain name, a server domain history and a server domain name history, a packet size, a TCP retransmission information, and a TCP out-of-sequence packet reception, and wherein the plurality of device parameters comprise a round-trip latency, a Media Access Control (MAC) address, a domain history, a domain name history, a data traffic history, a maximum daily byte usage, a minimum daily byte usage, a maximum number of domains, a minimum number of domains, a minimum downstream percentage, a maximum downstream percentage, a device IP address, device statistics, a device manufacturer name, a TCP connection establishment information and a TCP segment acknowledgement latency, a LAN congestion, and a device network connectivity.

3. The router of claim 1, wherein in monitoring the data packets communicated between the WAN and the plurality of customer premise equipment during the upstream transmission and the downstream transmission, the router is to:
receive an upstream data packet corresponding to the plurality of customer premise equipment;
extract a source MAC address, and an IP address associated with the received upstream data packet;
map the extracted source MAC address and the IP address with a pre-stored MAC address and a pre-stored IP address;
determine a manufacturer name associated with the plurality of customer premise equipment based on the mapping;
extract a server domain and a server domain name from the received upstream data packet based on a type of the upstream data packet;
update a device upstream traffic information with a packet size in a device traffic history table; and
update each device table entry for each of the plurality of customer premise equipment by applying the predefined device match rules.

4. The router of claim 1, wherein in monitoring the data packets communicated between the WAN and the plurality of customer premise equipment during the upstream transmission and the downstream transmission, the router is to:
receive a downstream data packet to be transmitted to the plurality of customer premise equipment from the WAN;
extract an IP address associated with the received downstream data packet;
update a device downstream traffic information with a packet size in a device traffic history table; and
update each device table entry for each of the plurality of customer premise equipment by applying the predefined device match rules.

5. The router of claim 1, wherein in validating the plurality of packet parameters and the plurality of device parameters based on the predefined device match rules, the router is to:
compare at least one of the plurality of packet parameters and the plurality of device parameters with the predefined device match rules;
determine at least one matching rule with a highest resulting score based on comparison, wherein the at least one matching rule is configured as a comma-separated value list of comprising key-value pairs; and
identify at least one of a MAC address, a vendor value and a hostname corresponding to the determined at least one matching rule.

6. The router of claim 1, wherein in identifying the customer premise equipment along with the plurality of characteristics from the plurality of customer premise equipment based on the results of validation, the router is to:
identify a type of the customer premise equipment based on at least one matching rule, wherein the at least one matching rule comprises pre-stored device parameters and pre-stored packet parameters matching the plurality of packet parameters and the plurality of device parameters;
determine a device name and a device description associated with the identified type of customer premise equipment based on the at least one matching rule; and
determine at least one of an operating system hosted on the customer premise equipment and at least one latest applications used by the customer premise equipment.

7. The router of claim 1, wherein the router is to:
determine a status information and a performance information associated with the customer premise equipment based on the plurality of characteristics and the predefined device match rules, wherein the performance information comprises a device network latency measurement and packet loss measurements;
determine at least one issue associated with the identified customer premise equipment based on the status information and the performance information;
generate a plurality of recommendations corresponding to the at least one issue based on pre-stored rules, wherein the plurality of recommendations comprise a plurality of troubleshooting solutions for the determined at least one issue; and
transmit the generated plurality of recommendations to at least one of plurality of user devices and a server managing the router.

8. The router of claim 7, wherein in determining the status information and the performance information associated with the customer premise equipment based on the plurality of characteristics and the predefined device match rules, the router is to:
measure at least one of a round-trip latency of the identified customer premise equipment and an upstream and a downstream packet loss of the identified customer premise equipment, wherein the round-trip latency is measured by monitoring an acknowledgement (ACK) time of the data packets during the downstream transmission, and wherein the upstream and the downstream packet loss are measured by monitoring the data packets;
determine a signal strength of the identified customer premise equipment based on a MAC address associated with the identified customer premise equipment and the measured at least one of the round-trip latency and the upstream and the downstream packet loss; and
determine the status information of the identified customer premise equipment based on the measured at least one of the round-trip latency and the upstream and the downstream packet loss, wherein the status information comprises one of a device active state and a device idle state, and wherein the status information further comprises at least one of the MAC address, an IP address, a server domain name history, a server domain history, a traffic history, and a MAC manufacturer information.

9. The router of claim 7, wherein in determining the at least one issue associated with the customer premise equipment based on the status information and the performance information, the router is to:
evaluate the at least one of the round-trip latency of the identified customer premise equipment and the upstream and the downstream packet loss of the identified customer premise equipment based on a pre-set threshold values;
evaluate the signal strength of the identified customer premise equipment based on the pre-set threshold values; and
determine the at least one issue associated with the identified customer premise equipment based on evaluated round-trip latency, the upstream and the downstream packet loss and the evaluated signal strength, wherein the at least one issue comprises at least one of a signal connectivity issue, network congestion issue, a round-trip time issue, a customer premise equipment infrastructure issue, a packet loss issue, and a TCP packet sequence number error issue.

10. The router of claim 7, wherein in generating the plurality of recommendations corresponding to the at least one issue based on the pre-stored rules, the router is to:
map the determined at least one issue with a corresponding prestored issue;
identify a plurality of troubleshooting solutions for the determined at least one issue based on the mapping; and
generate a plurality of recommendations for the determined at least one issue, wherein the plurality of recommendations comprise the identified plurality of troubleshooting solutions.

11. The router of claim 1, wherein the router is to:
identify a customer premise equipment along with a plurality of characteristics from the plurality of customer premise equipment based on results of the validation, wherein the plurality of characteristics comprise a device type, a device name, and a device description;
measure at least one of a round-trip latency of the identified customer premise equipment and an upstream and a downstream packet loss of the identified customer premise equipment, wherein the round-trip latency is measured by monitoring an acknowledgement (ACK) time of the data packets during the downstream transmission and a TCP sequence number, and wherein the upstream and the downstream packet loss are measured by monitoring the data packets; and
determine the at least one issue associated with the identified customer premise equipment based on measured round-trip latency, and the upstream and the downstream packet loss, wherein the at least one issue comprises at least one of a signal connectivity issue, network congestion issue, a round-trip time issue, a customer premise equipment infrastructure issue, a packet loss issue, and a TCP packet sequence number error issue.

12. A method comprising:
monitoring, by a processor, data packets communicated between a Wide Area Network (WAN) and a plurality of customer premise equipment during an upstream transmission and a downstream transmission;
determining, by the processor, a plurality of packet parameters associated with the data packets and a plurality of device parameters associated with the plurality of customer premise equipment based on the data packets;
validating, by the processor, the plurality of packet parameters and the plurality of device parameters based on predefined device match rules; and
identifying, by the processor, a customer premise equipment along with a plurality of characteristics from the plurality of customer premise equipment based on results of validation, wherein the plurality of characteristics comprise a device type, a device name, and a device description.

13. The method of claim 12, wherein monitoring the data packets communicated between the WAN and the plurality of customer premise equipment during the upstream transmission and the downstream transmission comprises:
receiving, by the processor, an upstream data packet corresponding to the plurality of customer premise equipment;
extracting, by the processor, a source MAC address, and an IP address associated with the upstream data packet;
mapping, by the processor, the source MAC address and the IP address with a pre-stored MAC address and a pre-stored IP address;
determining, by the processor, a manufacturer name associated with the plurality of customer premise equipment based on the mapping;
extracting, by the processor, a server domain, and a server domain name from the received upstream data packet based on a type of the upstream data packet;
updating, by the processor, a device upstream traffic information with a packet size in a device traffic history table; and
updating, by the processor, each device table entry for each of the plurality of customer premise equipment by applying the predefined device match rules.

14. The method of claim 12, wherein monitoring the data packets communicated between the WAN and the plurality of customer premise equipment during the upstream transmission and the downstream transmission comprises:
receiving, by the processor, a downstream data packet to be transmitted to the plurality of customer premise equipment from the WAN;
extracting, by the processor, an IP address associated with the received downstream data packet;
updating, by the processor, a device downstream traffic information with a packet size in a device traffic history table; and
updating, by the processor, each device table entry for each of the plurality of customer premise equipment by applying the predefined device match rules.

15. The method of claim 12, wherein validating the plurality of packet parameters and the plurality of device parameters based on the predefined device match rules comprises:
comparing, by the processor, at least one of the determined plurality of packet parameters and the plurality of device parameters with the predefined device match rules;
determining, by the processor, at least one matching rule with a highest resulting score based on comparison, wherein the at least one matching rule is configured as a comma-separated value list of comprising key-value pairs; and
identifying, by the processor, at least one of a MAC address, a vendor value and a hostname corresponding to the determined at least one matching rule.

16. The method of claim 12, wherein identifying the customer premise equipment along with the plurality of characteristics from the plurality of customer premise equipment based on the results of validation comprises:
identifying, by the processor, a type of the customer premise equipment based on at least one matching rule, wherein the at least one matching rule comprises pre-stored device parameters and pre-stored packet parameters matching the plurality of packet parameters and the plurality of device parameters;
determining, by the processor, a device name and a device description associated with the type of customer premise equipment based on the at least one matching rule; and
determining, by the processor, at least one of an operating system hosted on the customer premise equipment and at least one latest applications used by the customer premise equipment.

17. The method of claim 12, further comprising:
determining, by the processor, a status information and a performance information associated with the customer premise equipment based on the plurality of characteristics and the predefined device match rules, wherein the performance information comprises a device network latency measurement and packet loss measurements;
determining, by the processor, at least one issue associated with the identified customer premise equipment based on the status information and the performance information;
generating, by the processor, a plurality of recommendations corresponding to the at least one issue based on pre-stored rules, wherein the plurality of recommendations comprise a plurality of troubleshooting solutions for the determined at least one issue; and
transmitting, by the processor, the generated plurality of recommendations to at least one of plurality of user devices and a server managing a router.

18. The method of claim 17, wherein determining the status information and the performance information associated with the customer premise equipment based on the plurality of characteristics and the predefined device match rules comprises:
measuring, by the processor, at least one of a round-trip latency of the identified customer premise equipment and an upstream and a downstream packet loss of the identified customer premise equipment, wherein the round-trip latency is measured by monitoring an acknowledgement (ACK) time of the data packets during the downstream transmission, and wherein the upstream and the downstream packet loss are measured by monitoring the data packets;
determining, by the processor, a signal strength of the identified customer premise equipment based on a MAC address associated with the identified customer premise equipment and the measured at least one of the round-trip latency and the upstream and the downstream packet loss; and
determining, by the processor, the status information of the identified customer premise equipment based on the measured at least one of the round-trip latency and the upstream and the downstream packet loss, wherein the status information comprises one of a device active state and a device idle state, and wherein the status information further comprises at least one of the MAC address, an IP address, a server domain name history, a server domain history, a traffic history and a MAC manufacturer information.

19. The method of claim 17, wherein determining the at least one issue associated with the customer premise equipment based on the status information and the performance information comprises:
evaluating, by the processor, the at least one of the round-trip latency of the customer premise equipment and the upstream and the downstream packet loss of the identified customer premise equipment based on a pre-set threshold values;
evaluating, by the processor, the signal strength of the identified customer premise equipment based on the pre-set threshold values; and
determining, by the processor, the at least one issue associated with the identified customer premise equipment based on evaluated round-trip latency, the upstream and the downstream packet loss and the evaluated signal strength, wherein the at least one issue comprises at least one of a signal connectivity issue, network congestion issue, a round-trip time issue, a customer premise equipment infrastructure issue, a packet loss issue, and a packet sequence number error issue.

20. A non-transitory computer-readable medium comprising machine-readable instructions that are executable by a processor to:
monitor data packets communicated between a wide area network (WAN) and a plurality of customer premise equipment during an upstream transmission and a downstream transmission;
determine a plurality of packet parameters associated with the monitored data packets and a plurality of device parameters associated with the plurality of customer premise equipment based on the monitored data packets;
validate the plurality of packet parameters and the plurality of device parameters based on predefined device match rules; and
identify the customer premise equipment along with a plurality of characteristics from the plurality of customer premise equipment based on results of validation, wherein the plurality of characteristics comprise a device type, a device name, and a device description.
